(19) United States
(12) Patent Application Publication
(10) Pub. No.: US 2019/0387778 A1
(43) Pub. Date: Dec. 26, 2019

(54) HEAT-TREATED TOMATO PRODUCT AND TOMATO-BASED FOOD OR BEVERAGE, AND METHOD FOR PRODUCING SAME

(71) Applicant: MIZKAN HOLDINGS CO., LTD., Aichi (JP)

(72) Inventors: Jyoto Yoshimoto, Aichi (JP); Takeki Saito, Aichi (JP)

(73) Assignee: MIZKAN HOLDINGS CO., LTD., Aichi (JP)

(21) Appl. No.: 16/553,663

(22) Filed: Aug. 28, 2019

Related U.S. Application Data
(63) Continuation of application No. PCT/JP2018/006886, filed on Feb. 26, 2018.

(30) Foreign Application Priority Data
Feb. 28, 2017 (JP) 2017-036258

(51) Int. Cl. A23L 19/00; A23L 23/00; A23L 2/02; A23L 27/20

(52) U.S. Cl. CPC A23L 19/09; A23L 23/00; A23V 2002/00; A23L 27/2056; A23L 27/2026; A23L 2/02

(57) ABSTRACT

A heat-treated tomato product includes a heat-treated tomato containing 3-hexenol and 2-isobutylthiazole. A content of 2-isobutylthiazole in the heat-treated tomato product ranges from 2.0 to 1000 ppb, and a mass ratio of 3-hexenol to 2-isobutylthiazole in the heat-treated tomato product ranges from 1.0:1.5 to 1.0:25.2. A method for producing a heat-treated tomato product includes crushing or grinding raw material tomatoes, preparing a heat-treated tomato comprising flavor components by heating the crushed or ground tomatoes, and adjusting contents of the flavor components in the heat-treated tomato product. The flavor components include 2-isobutylthiazole and 3-hexenol. A content of 2-isobutylthiazole in the heat-treated tomato product is adjusted to be in a range of 2.0 to 1000 ppb, and a mass ratio of 3-hexenol to 2-isobutylthiazole in the heat-treated tomato product is adjusted to be in a range of 1.0:1.5 to 1.0:25.2.

### TECHNICAL FIELD

One or more embodiments of the present invention relate to a heat-treated tomato product in which fresh feeling and stewed feeling of a freshly cooked tomato dish similar to those of a freshly homemade cooked tomato dish are enhanced and maintained, a tomato-based food or beverage containing the heat-treated tomato product, and a method for producing the same.

### BACKGROUND

Hitherto, commercially available heat-treated tomato products such as tomato paste, tomato puree, and tomato juice have been produced by appropriately adjusting the concentration of a crushed tomato product via heat concentration, followed by heat sterilization. A variety of tomato-based foods or beverages seasoned by mixing other raw materials with such heat-treated tomato products are also mass-produced and sold. However, in the above-described heat treatment, along with the evaporation of water accompanying heating, flavor components that affect flavor and taste are volatilized off, the produced heat-treated tomato product and various tomato-based foods or beverages containing such product cannot provide fresh feeling and stewed feeling of a freshly cooked tomato dish similar to those of a freshly homemade cooked tomato dish, and the flavor or taste of the product becomes plain and unsatisfactory. In addition, in the case of heat sterilization treatment, regardless of heat treatment in an open or closed environment, degradation of flavor components, reaction between flavor components, and reaction between the flavor components and other components are induced, resulting in similar consequences. Further, even in the case of a processed tomato product (e.g., diced tomato or whole tomato) subjected to heat treatment for inactivating an enzyme (inactivating tomato-derived pectinase) in order to suppress the collapse of tomato tissue and maintain the solid state, the heat treatment causes similar consequences. Furthermore, even during display and storage at the time of selling, deterioration due to such degradation or reaction of flavor components causes the flavor or taste to become plain.

Therefore, there has been a strong demand to enhance and maintain fresh feeling and stewed feeling derived from complex flavor components of a tomato dish that is freshly cooked by homemade cooking in a heat-treated tomato product or a tomato-based food or beverage containing a heat-treated tomato product in order to improve preference of the product.

There have been various ideas to maintain fresh feeling of a heat-treated tomato product or a tomato-based food or beverage containing a heat-treated tomato product. For example. Patent Literature 1 discloses a method in which preliminary heating is performed to heat crushed tomato fruits at a temperature increase rate of 30° C. to 50° C./minute to 60° C. to 70° C. in order to obtain squeezed tomato juice which maintains fresh aroma that tomato fruits originally have at an enhanced level. However, in a case in which the squeezed tomato juice obtained by this method is processed to tomato puree or tomato paste, it takes a long time for concentration to achieve the viscosity and concentration as a tomato concentrate, and the production efficiency is poor. In addition, since preliminary heating that requires strict temperature control and time management is performed, the production step is complicated.

Patent Literature 2 teaches that it is possible to obtain tomato ketchup in which a fresh aroma that is felt in raw material tomatoes can be enhanced by adjusting contents of sugar, potassium, and sodium in a specific range, and which is excellent in terms of the balance of tastes. However, a target processed tomato product in Patent Literature 2 is only tomato ketchup. In a case in which the contents of the components are adjusted in the same manner in a different processed tomato product, the taste or flavor originally felt in the processed tomato product cannot be obtained.

In addition, Patent Literature 3 discloses a processed tomato product having fruity feeling (fruity aroma) and containing: component (A): 6-methyl-5-hepten-2-one; component (B): 2-isobutylthiazole; component (C): at least one of volatile component selected from furfural, dimethyl sulfide, dimethyl disulfide, and dimethyl trisulfide at specific proportions, and a method for producing the same. However, it is described that as a result of heat treatment at more than 90° C., the “fruity aroma” is very weak and “odor generated by heat” is strong, resulting in a generally undesirable aroma (Patent Literature 3, paragraph 0070, Comparative Example 4 in Table 1).

In addition, the “fresh aroma” or “fruity aroma” obtained from the processed tomato product of the prior art is a fresh aroma of raw tomato fruits, which is different from fresh feeling and stewed feeling derived from complex flavor components of a tomato dish freshly cooked by homemade cooking.

### CITATION LIST

### Patent Literature

Patent Literature 1: JP Patent Publication (Kokai) No. 2003-179 A

Patent Literature 2: JP Patent Publication (Kokai) No. 2012-213393 A

Patent Literature 3: JP Patent Publication (Kokai) No. 2011-72306 A

### SUMMARY

One or more embodiments of the present invention provide a heat-treated tomato product in which fresh feeling and stewed feeling of a freshly cooked tomato dish are enhanced and maintained, and a tomato-based food or beverage containing the heat-treated tomato product, without going through complicated production steps.

The present inventors compared and analyzed flavor components before and after heat concentration in a tomato concentrate as an example of a heat-treated tomato product. As a result, the inventors found that among many existing flavor components, 3-hexenol, 2-isobutylthiazole, and 6-methyl-5-hepten-2-one (hereinafter also referred to as “flavor components according to one or more embodiments of the present invention”) are unlikely to be volatilized off by heating and have heating resistance. The present inventors also found that it is possible to produce a heat-treated tomato product in which fresh feeling and stewed feeling of a freshly cooked tomato dish are enhanced and the feelings are maintained for a long period of time, and a tomato-based food or beverage containing the heat-treated tomato product, by a convenient method for adjusting the contents of the flavor components in a heat-treated tomato product and the content ratio thereof within a specific range.

Specifically, one or more embodiments of the present invention encompass the following.

[1] A heat-treated tomato product containing 3-hexenol and 2-isobutylthiazole, wherein the content of 2-isobutylthiazole in the heat-treated tomato product is in a range of 2.0 ppb of 1000 ppb, and the content ratio between 3-hexenol and 2-isobutylthiazole is 1.0:1.5 to 1.0:25.2 at a mass ratio.
[2] A heat-treated tomato product containing 3-hexenol, 2-isobutylthiazole, and 6-methyl-5-hepten-2-one, wherein when the content of 2-isobutylthiazole in the heat-treated tomato product is 2.0 ppb to 1000 ppb, the content ratio between 3-hexenol and 2-isobutylthiazole is 1.0:1.5 to 1.0:10.0 at a mass ratio, and the content ratio between 3-hexenol and 6-methyl-5-hepten-2-one is 1.0:2.0 to 1.0:15.0 at a mass ratio.
[3] The heat-treated tomato product according to [1] or [2], which has a Brix value of 6 to 34.
[4] The heat-treated tomato product according to any one of [1] to [3], which is treated by heat sterilization at 70° C. to 100° C. for 3 minutes to 20 minutes.
[5] A tomato-based food or beverage containing the heat-treated tomato product according to any one of [1] to [4].
[6] The tomato-based food or beverage according to [5], wherein the content of the heat-treated tomato product in the tomato-based food or beverage is 20% by mass to 100% by mass.
[7] The tomato-based food or beverage according to [5] or [6], which is treated by heat sterilization at 70° C. to 100° C. for 3 minutes to 20 minutes.
[8] A method for producing a heat-treated tomato product or a tomato-based food or beverage, comprising: a step of crushing or grinding and then heat-treating raw material tomatoes to prepare a heat-treated tomato product; and a step of adjusting the contents of 2-isobutylthiazole and 3-hexenol which are flavor components in the heat-treated tomato product and the content ratio thereof such that the following conditions are satisfied:

(a1) the content of 2-isobutylthiazole is in a range of 2.0 ppb to 1000 ppb; and

(a2) the content ratio between 3-hexenol and 2-isobutylthiazole is 1.0:1.5 to 1.0:25.2 at a mass ratio.

[9] A method for producing a heat-treated tomato product or a tomato-based food or beverage, comprising: a step of crushing or grinding and then heat-treating raw material tomatoes to prepare a heat-treated tomato product; and a step of adjusting the contents of 2-isobutylthiazole, 3-hexenol, and 6-methyl-5-hepten-2-one which are flavor components in the heat-treated tomato product and the content ratio thereof such that the following conditions are satisfied:

(b1) the content of 2-isobutylthiazole is in a range of 2.0 ppb to 1000 ppb;

(b2) the content ratio between 3-hexenol and 2-isobutylthiazole is 1.0:1.5 to 1.0:10.0 at a mass ratio; and

(b3) the content ratio between 3-hexenol and 6-methyl-5-hepten-2-one is 1.0:2.0 to 1.0:15.0 at a mass ratio.

[10] The production method according to [8] or [9], wherein the adjustment of the contents of the flavor components in the heat-treated tomato product and the content ratio thereof is carried out by one or more methods selected from the group consisting of (i) to (v) described below:

(i) a method for adding the flavor components to the heat-treated tomato product;

(ii) a method for adding a flavoring agent containing the flavor components to the heat-treated tomato product;

(iii) a method for adding a food material containing the flavor components to the heat-treated tomato product;

(iv) a method for mixing non-concentrated tomatoes and/or low-concentrated tomatoes with the heat-treated tomato product; and

(v) a method using raw material tomatoes of a tomato cultivar and/or unripe fruits having high contents of the flavor components.

[11] The production method according to any one of [8] to [10], wherein the heat-treated tomato product is mixed with other raw materials such that the content of the heat-treated tomato product in the tomato-based food or beverage is adjusted to 20% by mass to 100% by mass.
[12] The production method according to any one of [8] to [11], wherein a step of adjusting the Brix of the heat-treated tomato product in a range of 6 to 34 is carried out.
[13] The production method according to any one of [8] to [12], comprising a step of treating the heat-treated tomato product or tomato-based food or beverage by heat sterilization at 70° C. to 100° C. for 3 minutes to 20 minutes.
[14] A method for enhancing and maintaining fresh feeling and stewed feeling of a freshly cooked tomato dish in a heat-treated tomato product or a tomato-based food or beverage containing the heat-treated tomato product, comprising adjusting the contents of 2-isobutylthiazole and 3-hexenol which are flavor components in the heat-treated tomato product and the content ratio thereof such that the following conditions are satisfied:

(a1) the content of 2-isobutylthiazole is in a range of 2.0 ppb to 1000 ppb; and

(a2) the content ratio between 3-hexenol and 2-isobutylthiazole is 1.0:1.5 to 1.0:25.2 at a mass ratio.

[15] A method for enhancing and maintaining fresh feeling and stewed feeling of a freshly cooked tomato dish in a heat-treated tomato product or a tomato-based food or beverage containing the heat-treated tomato product, comprising adjusting the contents of 2-isobutylthiazole, 3-hexenol, and 6-methyl-5-hepten-2-one which are flavor components in the heat-treated tomato product and the content ratio thereof such that the following conditions are satisfied:

(b1) the content of 2-isobutylthiazole is in a range of 2.0 ppb to 1000 ppb;

(b2) the content ratio between 3-hexenol and 2-isobutylthiazole is 1.0:1.5 to 1.0:10.0 at a mass ratio; and

(b3) the content ratio between 3-hexenol and 6-methyl-5-hepten-2-one is 1.0:2.0 to 1.0:15.0 at a mass ratio.

[16] The method according to [14] or [15], wherein the adjustment of the contents of the flavor components in the heat-treated tomato product and the content ratio thereof is carried out by one or more methods selected from the group consisting of (i) to (v) described below:

(i) a method for adding the flavor components to the heat-treated tomato product;

(ii) a method for adding a flavoring agent containing the flavor components to the heat-treated tomato product;

(iii) a method for adding a food material containing the flavor components to the heat-treated tomato product;

(iv) a method for mixing non-concentrated tomatoes and/or low-concentrated tomatoes with the heat-treated tomato product; and

(v) a method using raw material tomatoes of a tomato cultivar and/or unripe fruits having high contents of the flavor components.

[17] The method according to any one of [14] to [16], wherein a step of adjusting the Brix of the heat-treated tomato product in a range of 6 to 34 is carried out.
[18] The method according to any one of [14] to [17], comprising a step of treating the heat-treated tomato product or tomato-based food or beverage by heat sterilization at 70° C. to 100° C. for 3 minutes to 20 minutes.
[19] A method for enhancing fresh feeling and stewed feeling of a tomato dish by using the heat-treated tomato product according to any one of [1] to [4] and/or the tomato-based food or beverage according to any one of [5] to [7] for the tomato dish.

The present application claims priority from Japanese Patent Application No. 2017-036258, filed on Feb. 28, 2017; the disclosure of which is hereby incorporated by reference.

According to one or more embodiments of the present invention, a heat-treated tomato product in which fresh feeling and stewed feeling of a freshly cooked tomato dish similar to those of a freshly homemade cooked tomato dish are enhanced and stably long-term maintained, and a tomato-based food or beverage containing the heat-treated tomato product, are provided. The heat-treated tomato product and tomato-based food or beverage according to one or more embodiments of the present invention can be produced by a convenient method including adjusting flavor components at specific contents and a content ratio thereof without going through complicated production steps.

### BRIEF DESCRIPTION OF DRAWINGS

FIG. 1 shows a flow for producing a heat-treated tomato product (tomato concentrate) and a tomato-based food or beverage by a conventional method.

FIG. 2 shows a flow for producing a heat-treated tomato product and a tomato-based food or beverage by the method according to one or more embodiments of the present invention in which the flavor components per se are added to a heat-treated tomato product (tomato concentrate).

FIG. 3 shows a flow for producing a heat-treated tomato product and a tomato-based food or beverage by the method according to one or more embodiments of the present invention in which a flavoring agent containing the flavor components is added to a heat-treated tomato product (tomato concentrate).

FIG. 4 shows a flow for producing a heat-treated tomato product and a tomato-based food or beverage by the method according to one or more embodiments of the present invention in which a food material containing the flavor components is added to a heat-treated tomato product (tomato concentrate).

FIG. 5 shows a flow for producing a heat-treated tomato product and a tomato-based food or beverage by a method in which non-concentrated tomatoes (not subjected to the heat concentration step) and/or low-concentrated tomatoes are mixed with a heat-treated tomato product (tomato concentrate).

FIG. 6 shows a flow for producing a heat-treated tomato product (tomato concentrate) and a tomato-based food or beverage by the method according to one or more embodiments of the present invention in which a tomato cultivar and/or unripe fruits having high contents of the flavor components are used.

FIG. 7 shows a flow for producing a heat-treated tomato product and a tomato-based food or beverage by a method in which the flavor components are added to a heat-treated tomato product (sterilized tomato product).

FIG. 8 shows a flow for producing a heat-treated tomato product and a tomato-based food or beverage by a method in which the flavor components are added to a heat-treated tomato product (enzymatically inactivated tomato product).

FIG. 9 shows flavor component analysis results (analysis chart) of a tomato concentrate (subjected to the heat concentration step) by a conventional method.

FIG. 10 shows flavor component analysis results (analysis chart) of a crushed tomato product (not subjected to the heat concentration step).

### DETAILED DESCRIPTION OF EMBODIMENTS

### 1. Heat-Treated Tomato Products and Tomato-Based Foods or Beverages

The “heat-treated tomato product” according to the present invention is a processed tomato product obtained by heat-treating tomatoes. The “heat-treated tomato product” according to one or more embodiments of the present invention encompasses, for example, a processed tomato product (tomato concentrate) prepared by subjecting a crushed or ground tomato product obtained by crushing or grinding raw material tomatoes to heat concentration and, for example, heat concentration under reduced pressure, a processed tomato product (sterilized tomato product) prepared by treating a crushed or ground tomato product by heat sterilization without concentration, and a processed tomato product (enzymatically inactivated tomato product) subjected to heat treatment for inactivating an enzyme (inactivating tomato-derived pectinase) in order to suppress the collapse of tomato tissue and maintain the solid state (e.g., the diced form). Examples of product forms of processed tomato products include tomato puree, tomato paste, tomato juice, diced tomato, whole tomato, and mixtures thereof. In addition, according to one or more embodiments of the present invention, the term “tomato-based food or beverage” refers to a food or beverage containing the above-described heat-treated tomato product, which is prepared by mixing other raw materials and the like with the heat-treated tomato product and appropriately flavoring the resulting product. It also includes an unflavored heat-treated tomato product (100% processed tomato product).

The “heat-treated tomato product” according to one or more embodiments of the present invention is characterized in that it contains 3-hexenol and 2-isobutylthiazole, or 3-hexenol, 2-isobutylthiazole, and 6-methyl-5-hepten-2-one at specific contents and a content ratio thereof.

Three components, which are 3-hexenol (cis-3-hexen-1-ol (CAS No. 928-96-1)), 2-isobutylthiazole (CAS No. 18640-74-9), and 6-methyl-5-hepten-2-one (CAS No. 110-934)), each have different smell quality, and do not independently provide fresh feeling and stewed feeling of a freshly cooked tomato dish similar to those of a freshly homemade cooked tomato dish. Specifically, 3-hexenol has a green grassy smell that plants generally have, 2-isobutylthiazole has a smell of damp soil, and 6-methyl-5-hepten-2-one has a flowery sweet smell. These components are a part of flavor components which tomatoes originally contain.

Apart from the above components, there are a wide variety of components as a flavor component that tomatoes originally have, which include, for example, 2-hexenal (CAS No. 6728-26-3, green grassy smell of plants) and 3-hexenal (CAS No. 6789-80-6, sweet smell of plants). The boiling points of the two components are 146° C. and 126° C., respectively, while the boiling point of 3-hexenol is 157° C., the boiling point of 2-isobutylthiazole is 180° C., and the boiling point of 6-methyl-5-hepten-2-one is 173° C. Thus, it can be said that the three components are flavor components which have higher boiling points and are relatively stable against heat load.

According to one or more embodiments of the present invention, “fresh feeling and stewed feeling of a freshly cooked tomato dish” is associated with a flavor derived from complex flavor components which is felt when preparing a tomato dish by homemade cooking. The flavor is a freshly cooked flavor of a tomato dish immediately after cooking and processing, which is different from fresh feeling or fruity feeling of fresh raw tomato fruits that are felt when eating tomato salad. Types of tomato dish specified herein are not particularly limited as long as tomatoes are used. However, examples thereof include tomato pasta, meat sauce spaghetti, tomato stew, rolled cabbage, ratatouille, minestrone, tomato risotto, tomato and rice gratin, tomato gratin, tomato lasagna, tomato stew, and tomato pizza.

Although the fresh feeling and stewed feeling of a freshly cooked tomato dish can also be obtained using two flavor components which are 3-hexenol and 2-isobutylthiazole, it may be preferable to further add 6-methyl-5-hepten-2-one because quality of the fresh feeling and stewed feeling of a freshly cooked tomato dish are further enhanced.

In a case in which the fresh feeling and stewed feeling of a freshly cooked tomato dish are obtained using two components, which are 3-hexenol and 2-isobutylthiazole, the content of 2-isobutylthiazole and the content ratio between 3-hexenol and 2-isobutylthiazole in the heat-treated tomato product according to one or more embodiments of the present invention are adjusted to fall within specific ranges.

When the content of 2-isobutylthiazole in the heat-treated tomato product according to one or more embodiments of the present invention is in a range of 2.0 ppb to 1000 ppb, stewed feeling of a freshly cooked tomato dish of interest can be enhanced and maintained. In view of the balance of aromas and rich taste, it may be preferably in a range of 2.0 ppb to 200 ppb and more preferably in a range of 5.0 ppb to 50 ppb. The aroma of 2-isobutylthiazole is relatively strongly felt, compared to other flavor components, and the quality of aroma is a damp soil-like smell. Therefore, when the content of 2-isobutylthiazole is higher than 1000 ppb, the balance of aromas is easily broken in a heat-treated tomato product and a tomato-based food or beverage, and when the content of 2-isobutylthiazole is lower than 2.0 ppb, stewed feeling of a freshly cooked tomato dish cannot be enhanced and maintained, which may not be preferable.

When the content of 2-isobutylthiazole in the heat-treated tomato product according to one or more embodiments of the present invention is 2.0 ppb to 1000 ppb, if the content ratio between 3-hexenol and 2-isobutylthiazole is 1.0:1.5 to 1.0:25.2 at a mass ratio, the fresh feeling and stewed feeling of a freshly cooked tomato dish of interest can be obtained. In view of the balance of aromas, it may be preferably in a range of 1.0:5.6 to 1.0:20.7, more preferably in a range of 1.0:10.0 to 1.0:15.3, and most preferably in a range of 1.0:10.0 to 1.0:12.7. When the content ratio between 3-hexenol and 2-isobutylthiazole is higher than the above range of the content ratio, a damp soil-like smell is too strong, and thus, the balance of aromas is impaired, which may not be preferable. In addition, the content ratio between 3-hexenol and 2-isobutylthiazole is lower than the above range of the content ratio, a green grassy smell is too strong, and thus, the balance of aromas is impaired, which may not be preferable.

In a case in which fresh feeling and stewed feeling of a freshly cooked tomato dish is obtained from three components which are 3-hexenol, 2-isobutylthiazole, and 6-methyl-5-hepten-2-one, the content of 2-isobutylthiazole, the content ratio between 3-hexenol and 2-isobutylthiazole, and the content ratio between 3-hexenol and 6-methyl-5-hepten-2-one in the heat-treated tomato product according to one or more embodiments of the present invention are adjusted to fall within specific ranges.

In this case, the range of the content of 2-isobutylthiazole in the heat-treated tomato product is the same as above. In addition, the content ratio between 3-hexenol and 2-isobutylthiazole in the heat-treated tomato product may be 1.0:1.5 to 1.0:10.0 and preferably 1.0:5.6 to 1.0:10.0 at a mass ratio, and the content ratio between 3-hexenol and 6-methyl-5-hepten-2-one may be 1.0:2.0 to 1.0:15.0 and preferably 1.0:4.0 to 1.0:15.0 at a mass ratio.

In other words, the content ratio among 3-hexenol and 2-isobutylthiazole and 6-methyl-5-hepten-2-one in the heat-treated tomato product according to one or more embodiments of the present invention may be preferably 1.0:1.5:2.0 to 1.0:10.0:15.0 and more preferably 1.0:1.5:4.0 to 1.0:10.0:15.0 at a mass ratio. When the content ratio among 3-hexenol and 2-isobutylthiazole and 6-methyl-5-hepten-2-one is in the above range, the balance of fresh feeling and stewed feeling of a freshly cooked tomato dish is favorable, and an overall flavor combined with other tastes (e.g., tastes such as delicious taste, sourness, sweetness, and bitterness, and ripeness of tomato) is strong, which may be preferable. When the content ratio between 3-hexenol or 2-isobutylthiazole and 6-methyl-5-hepten-2-one is higher than the above range of the content ratio, a flowery sweet smell is too strong, and thus, the balance of aromas is impaired and a sense of discomfort is felt, which may not be preferable. In addition, when the content ratio between 3-hexenol or 2-isobutylthiazole and 6-methyl-5-hepten-2-one is lower than the above range of the content ratio, the balance of aromas is impaired, which may not be preferable.

The above two or three flavor components may be added to the heat-treated tomato product according to one or more embodiments of the present invention in amounts determined by subtracting the contents of the two or three flavor components in the heat-treated tomato product to which the components are added from the amounts necessary for achieving the content and content ratio specified above.

The heat-treated tomato product according to one or more embodiments of the present invention has a Brix value of 6 to 34. From the viewpoints of the ease of mixing with other raw materials and the balance of flavors added to a tomato-based food or beverage when preparing a tomato-based food or beverage using the heat-treated tomato product, the Brix may be preferably in a range of 10 to 34 and more preferably in a range of 10 to 20. The Brix of the tomato-based food or beverage can be appropriately adjusted depending on the amount of a heat-treated tomato product used or the level of concentration of a heat-treated product used. In the case of a processed tomato product in the solid form. Brix may be measured by preparing paste of this processed tomato product.

Heat sterilization treatment conditions for a heat-treated tomato product and a tomato-based food or beverage according to one or more embodiments of the present invention may be in a range of 70° C. to 100° C. for 3 minutes from 20 minutes. However, if the conditions do not fall within the range, fresh feeling and stewed feeling of a freshly cooked tomato dish which are reproduced for preparation of the flavor components are lost again, which may not be preferable. In addition, from the viewpoint of preventing fresh feeling and stewed feeling of a freshly cooked tomato dish from being lost again, heat sterilization treatment conditions for a heat-treated tomato product and a tomato-based food or beverage are in a range of 70° C. to 100° C. for 3 minutes to 10 minutes, which may be more preferable.

The content of a heat-treated tomato product in the tomato-based food or beverage according to one or more embodiments of the present invention may be in a range of 20% by mass to 100% by mass, and a heat-treated tomato product (100% by mass) can also be exclusively used. When the content of a heat-treated tomato product in the tomato-based food or beverage is less than 20% by mass, fresh feeling and stewed feeling of a freshly cooked tomato dish are unlikely to be felt, which may not be preferable. From the viewpoints of the adjustment of levels of fresh feeling and stewed feeling of a freshly cooked tomato dish, strength of other tomato flavors, and/or possibility to prepare flavor and type variations by, for example, adding flavors/raw materials for providing other tastes, the content of a heat-treated tomato product in the tomato-based food or beverage may be preferably in a range of 40% by mass to 100% by mass and more preferably in a range of 60% by mass to 100% by mass.

The tomato-based food or beverage according to one or more embodiments of the present invention may contain generally used raw materials and additives for tomato-based foods or beverages as well as the above heat-treated tomato product unless the effects according to one or more embodiments of the present invention (effects of enhancing and maintaining fresh feeling and stewed feeling of a freshly cooked tomato dish and improving preference when eating) are impaired. Examples of such raw materials and additives include edible fats and oils, ethanol-containing products or nikiri-products (from which liquid has evaporated) thereof, acetic acid-containing products or nikiri-products thereof, spicy seasonings, aromatic materials, raw materials, common salts, sugars (sugar, fructose, glucose, starch syrup, isomerized glucose syrup, etc.), umami seasonings (protein hydrolysate, yeast extract, etc.), amino acid-based seasonings (glycine, alanine, sodium glutamate, etc.), nucleic acid-based seasonings (sodium inosinate, sodium guanylate, etc.), thickening agents (gums such as xanthan gum, locust gum or carrageenan, starches such as wheat starch or corn starch, etc.), acidulants (citric acid, lactic acid, malic acid, tartaric acid, etc.), antioxidants (tocopherol, cysteine hydrochloride, etc.), taste improvers (for example, a bitter taste suppressor, etc.), pH adjusters, and coloring agents. These raw materials and additives may be appropriately adjusted in type and amount according to the type and intended quality of a tomato-based food or beverage.

The “edible fat and oil” used in one or more embodiments of the present invention means fat and oil originated from plants, or fat and oil originated from animals. Examples of the fat and oil originated from plants include linseed oil, Akebia oil, avocado oil, almond oil, Argane oil, olive oil, mustard oil, canola oil, walnut oil, cranberry seed oil, grape seed oil, poppy seed oil, wheat germ oil, rice oil, corn oil, sesame oil, sasanqua oil, safflower oil, perilla oil, soybean oil, tea oil, camellia oil, rapeseed oil, palm oil, pumpkin seed oil, castor oil, sunflower oil, pistachio oil, peanut oil, hazelnut oil, macadamia nut oil, cotton seed oil, and coconut oil. Examples of the fat and oil originated from animals include butter, beef tallow, lard, mutton tallow, chicken fat, and fish oil. The edible fat and oil, which are a liquid at normal temperature, may be preferably hydrogenated, so that the fat and oil are converted to a solid or semi-solid state. The above-described edible fats and oils may be used alone as a single type, or may also be used in combination of two or more types.

Examples of “ethanol-containing products or nikiri-products thereof” used in one or more embodiments of the present invention include wine, sherry, other liquor derived from fruit juice, liquor derived from cereals, brewed alcohol or products obtained by heating these products to allow moisture to evaporate to volatilize ethanol so as to reduce or remove ethanol. The above-described ethanol-containing products or nikiri-products thereof may be used alone, or may also be used in combination of two or more types.

Examples of “acetic acid-containing products or nikiri-products thereof” used in one or more embodiments of the present invention include balsamic vinegar, wine vinegar, other vinegars from fruit juice, cereal-derived vinegars, brewed alcohol-derived vinegars, Chinese vinegar, synthetic vinegar, and products obtained by heating these vinegars to allow moisture to evaporate to volatilize acetic acid so as to reduce or remove acetic acid. The above-described acetic acid-containing products or nikiri-products thereof may be used alone, or may also be used in combination of two or more types. The term “nikiru (nikiri)” used above means heating liquors or vinegars to allow volatile components to evaporate.

The “spicy seasoning” used in one or more embodiments of the present invention means a part of a plant body (e.g., the fruit, pericarp, flower, bud, bark, stalk, leaf, seed, root, rhizome, etc., of a plant), which has specific aroma, stimulating taste and color tone, and is mixed into foods or beverages for the purpose of aromatization, deodorization, seasoning, coloration, etc. The spicy seasoning includes spice and herb.

Among such spicy seasonings, the spice means a spicy seasoning, from which stalks, leaves and flowers are excluded as utilized sites. Examples of the spice include pepper (black pepper, white pepper, and red pepper), garlic, ginger, sesame (sesame seeds), capsicum, horseradish (Armoracia rusticana), mustard, poppy seeds, yuzu, nutmeg, cinnamon, paprika, cardamom, cumin, saffron, allspice, clove, Japanese pepper, orange peel, fennel, licorice, fenugreek, Dill seed, Sichuan pepper, long pepper, and olive fruit. On the other hand, among such spicy seasonings, the herb means a spicy seasoning, the stalks, leaves and flowers of which are utilized. Examples of the herb include watercress, coriander, Japanese basil, celery, tarragon, chives, chervil, sage, thyme, laurel, leek, parsley, mustard green (Brassica juncea), Japanese ginger, mugwort, basil, oregano, rosemary, peppermint, savory, lemon grass, Dill, Japanese horseradish leaves, and Japanese pepper leaves. The above-described spicy seasonings may be used alone as a single type, or may also be used in combination of two or more types.

The “aromatic material” used in one or more embodiments of the present invention may be either a vegetable aromatic material or an animal aromatic material. Examples of the aromatic material include aromatic vegetables other than the above-described herb (broccoli, Japanese mustard spinach, pumpkin, carrot, onion, green pepper, etc.), nuts and seeds (almond, peanut, pine nut, sweet corn, coconut, soybeans, etc.), fruits (apple, olive, grape fruit, sudachi, pine apple, grape, mango, peach, yuzu, orange, lime, lemon, kabosu, plum, etc.), seafood (sardines, shrimp, crab, scallops, squid, octopus, clams, oysters, tuna, cod roe, etc.), meats of livestock animals (beef, pork, chicken, etc.), milk (bovine milk, ingredient adjusted milk, processed milk, etc.), dairy products (yogurt, cream, cheese, butter, buttermilk, ghee, whey, concentrated whey, ice cream, concentrated milk, condensed milk, whole milk powder, skimmed milk powder, milk-fermented liquor, milk fat, lactic acid bacteria drink, milk drink, casein, etc.), and processed products thereof. Examples of processed products used herein include a liquid product, concentrate, an extract, a dried product, a milled product (paste and puree), a granulated product, and a powdery product.

Raw materials other than tomatoes may be used for the tomato-based food or beverage according to one or more embodiments of the present invention. The term “raw material” used herein refers to a food material having a visually recognizable relatively large size, which is added in view of appearance, flavor, or accentuating the food texture, other than general raw materials and additives mentioned above. There is no particular limitation on the shape or processing form. Examples of the “raw material” is used in one or more embodiments of the present invention include cereals (white rice, brown rice, wheat, etc.), vegetables (green vegetables such as cabbage, spinach. Chinese cabbage, Japanese mustard spinach, or bok choy; root vegetables such as carrot Japanese white radish, or onion; fruit vegetables such as green pepper, or eggplant; stem vegetables such as asparagus or bamboo sprout; and flower vegetables such as broccoli or cauliflower), nuts and seeds (almond, peanut, pine nut, sweet corn, coconut, soybeans, etc.), mushrooms (shimeji mushrooms, shiitake mushrooms, mushrooms, king oyster mushrooms, maitake mushrooms, etc.), fruits (apple, pine apple, strawberry, peach, papaya, mango, etc.), beans (soybeans, peas, lentils, chickpeas, Egyptian beans, etc.), seafood (squid, shrimp, clams, scallops, mussels, etc.), meats of domesticated animals or processed meat products (beef, chicken, pork, ham, bacon, sausage, etc.), seaweeds (hijiki, wakame seaweed, kelp, etc.), eggs, milk-derived foods, and processed products thereof. The above-described raw materials may be used alone, or may also be used in combination of two or more types.

Further, the above-described edible fats and oils, ethanol-containing products or nikiri-products thereof, acetic acid-containing products or nikiri-products thereof, ingredients, spicy seasonings, and aromatic materials may be used alone, or may also be used in combination of two or more types.

In addition, type of the tomato-based food or beverage according to one or more embodiments of the present invention is not particularly limited as long as it is used as a tomato-based food or beverage. However, examples thereof include, pasta sauce, pizza sauce, salsa sauce, curry, stew, juice, soup, lagman, ketchup, chili sauce, barbecue sauce, dip sauce, spread, and dressing.

### 2. Method for Producing Heat-Treated Tomato Product or Tomato-Based Food or Beverage

The method for producing a heat-treated tomato product or a tomato-based food or beverage according to one or more embodiments of the present invention comprises: a step of crushing or grinding and then heat-treating raw material tomatoes to prepare a heat-treated tomato product; and a step of adjusting the contents of flavor components in the heat-treated tomato product and the content ratio thereof. The heat-treated tomato product can be prepared by concentrating a crushed or ground tomato product by heating, treating a crushed or ground tomato product by heat sterilization treatment without concentration, or by performing heat treatment for inactivating an enzyme (inactivating tomato-derived pectinase) in order to suppress the collapse of tomato tissue and maintain the solid state (e.g., the diced form). Cases in which a plurality of heat treatments are combined are also included.

Raw material tomatoes used herein may be any of whole tomato fruits, tomato fruits from which the fruit skin has been removed, tomato flesh from which the fruit skin and seeds have been removed, tomato fruit skin, tomato seeds, and tomato juice. In addition, these may be used alone, or may also be used in combination of two or more types. Alternatively, these may be separately used and subsequently mixed with a treated product.

Heat concentration such as heat concentration under reduced pressure described above may be performed by a known method using equipment such as a normal vacuum evaporation concentrator at, for example, 40° C. to 100° C. for 10 to 500 minutes.

Heat sterilization treatment described above may be performed by a known method using equipment such as a normal batch-type heat sterilization apparatus, and heat sterilization treatment conditions may be in a range of 70° C. to 100° C. for 3 minutes to 20 minutes. In addition, from the viewpoint of preventing fresh feeling and stewed feeling of a freshly cooked tomato dish from being lost again, the treatment may be performed more preferably at 70° C. to 100° C. for 3 minutes to 10 minutes. Enzyme inactivation treatment described above may be performed by a known method using equipment such as a normal batch-type heat treatment apparatus at, for example, 60° C. to 100° C. for 3 to 30 minutes.

The contents of flavor components (two components which are 2-isobutylthiazole and 3-hexenol or three components which are 2-isobutylthiazole, 3-hexenol, and 6-methyl-5-hepten-2-one) in a heat-treated tomato product and the content ratio thereof are the same as above. Moreover, the range may have a preferable range, a more preferable range, etc. by the reason described in the description of each item, so these ranges are also the same as above.

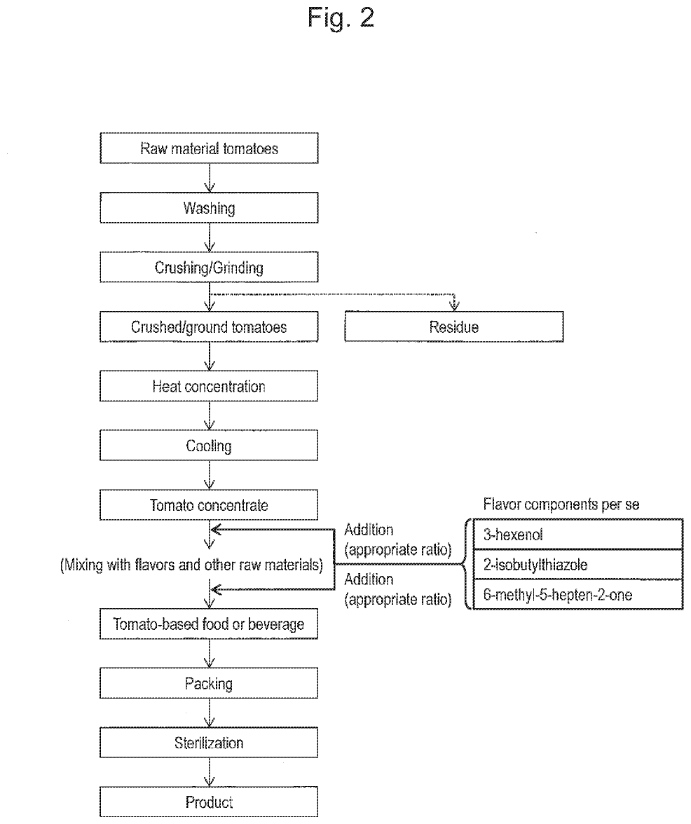

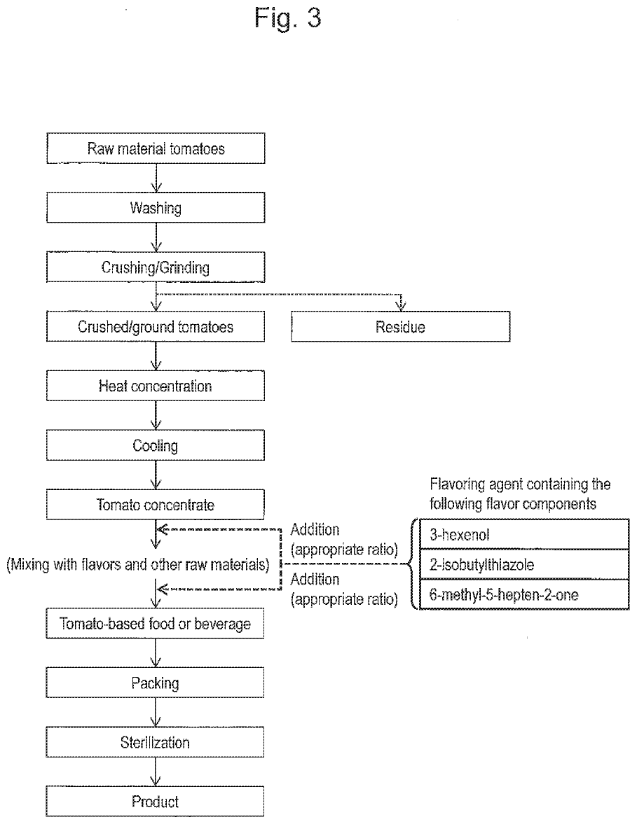

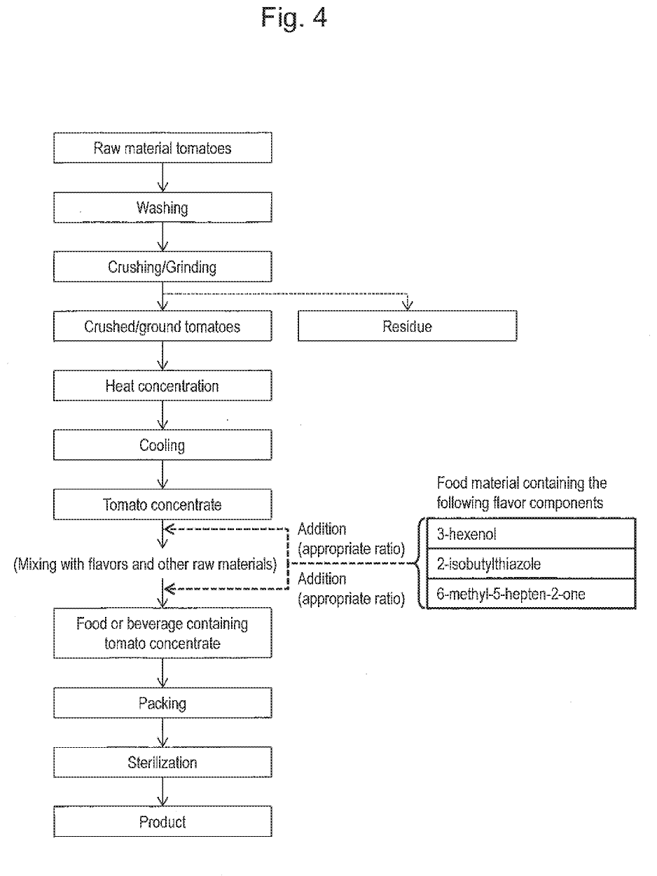

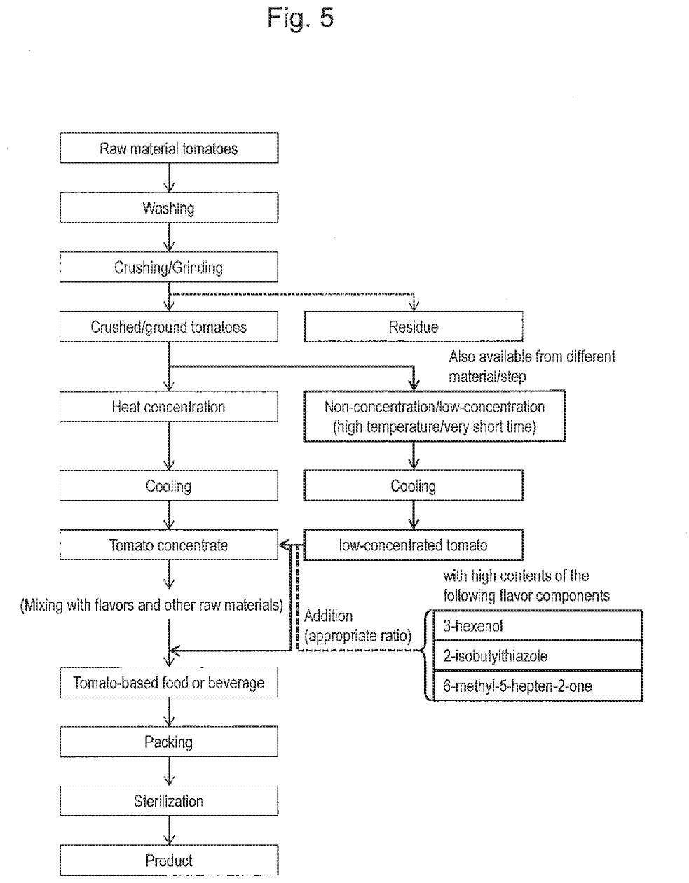

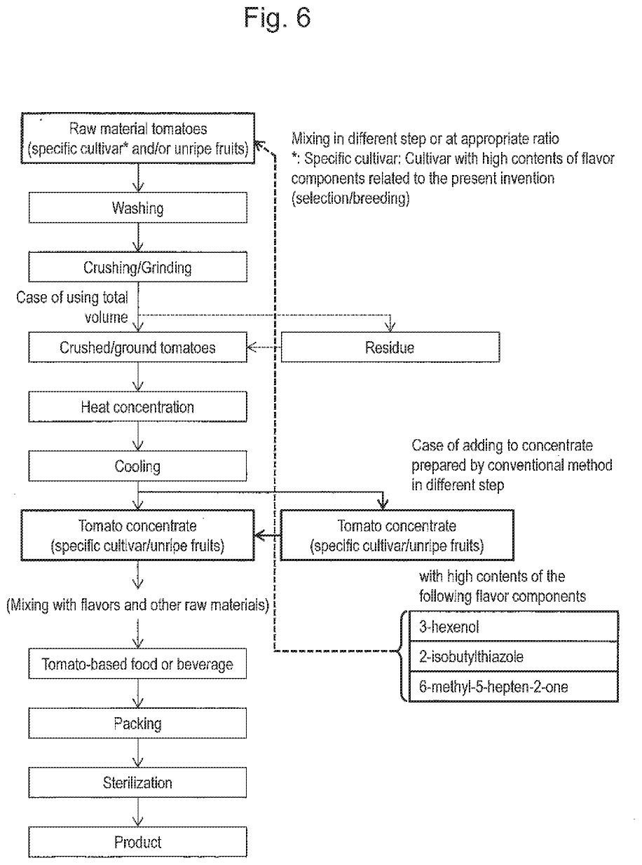

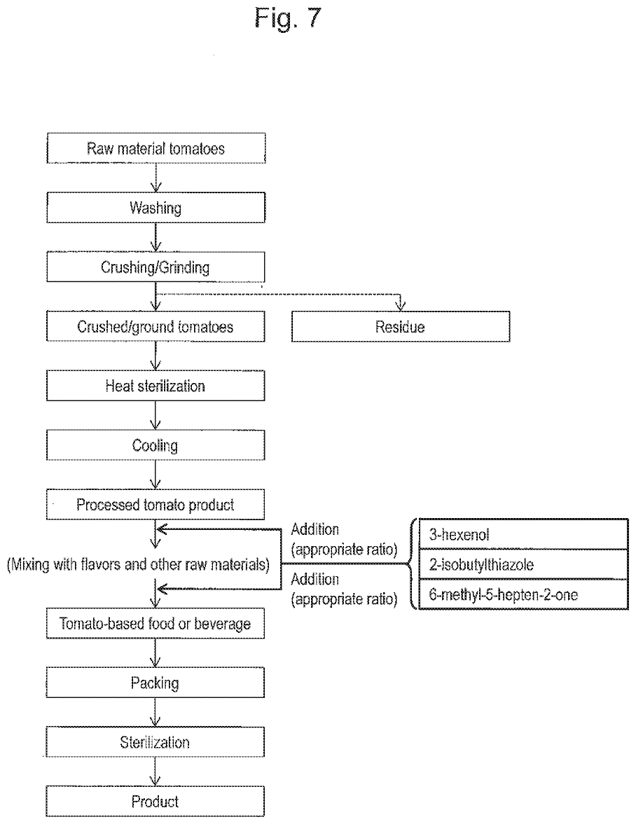

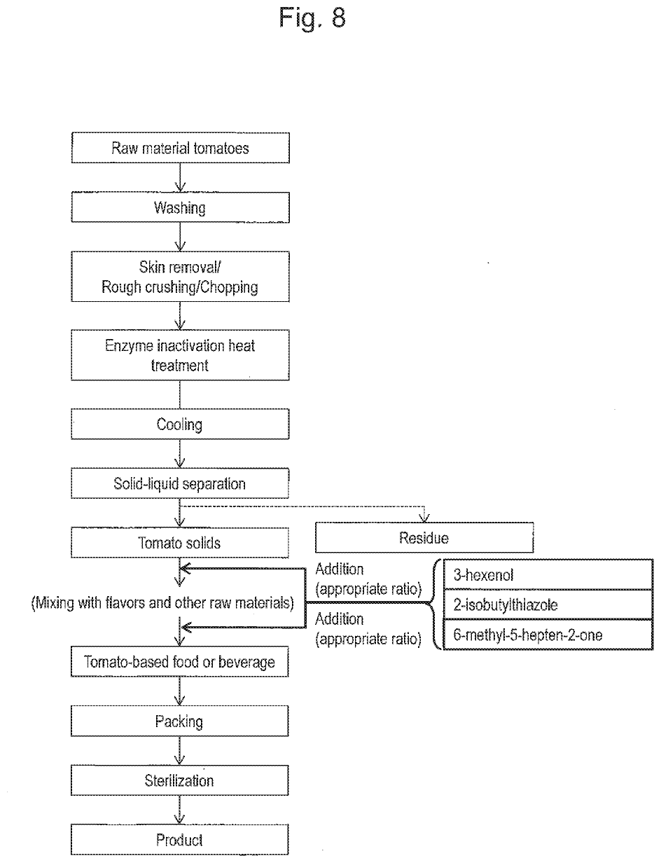

According to one or more embodiments of the present invention, a method for adjusting the contents of the flavor components and the content ratio thereof is not particularly limited as long as a sense of discomfort is not felt in the flavor of a heat-treated tomato product or a tomato-based food or beverage containing a heat-treated tomato product, and the method can be adopted to a usual production line. Examples thereof include, but are not limited to: (i) a method for adding the flavor components to the heat-treated tomato product (FIGS. 2, 7, and 8); (ii) a method for adding a flavoring agent containing the flavor components to the heat-treated tomato product (FIG. 3); (iii) a method for adding a food material containing the flavor components to the heat-treated tomato product (FIG. 4); (iv) a method for mixing non-concentrated tomatoes (not subjected to the heat concentration step) or low-concentrated tomatoes with the heat-treated tomato product (FIG. 5); and (v) a method using raw material tomatoes of a tomato cultivar and/or unripe fruits having high contents of the flavor components (FIG. 6). In addition, the above-described methods may be used alone, or may also be used in combination of two or more types. The above two or three flavor components may be added in (i) or (ii) in amounts determined by subtracting the contents of the flavor components in the heat-treated tomato product to which the components are added from the amounts necessary for achieving the content and content ratio specified above.

In the method for producing a heat-treated tomato product or a tomato-based food or beverage according to one or more embodiments of the present invention, flavor components, a flavoring agent containing flavor components, or a food material containing flavor components may be added to a heat-treated tomato product subjected to the heat treatment step in the step of producing a heat-treated tomato product, or may be added to a heat-treated tomato product upon or after mixing with other raw materials and additives in the step of producing a tomato-based food or beverage. Examples of a “food material” in (iii) include Solanaceous vegetables (e.g., bell peppers and paprikas containing large amounts of 3-hexenol, 2-isobutylthiazole, and 6-methyl-5-hepten-2-one, etc.) and processed products thereof (juice, paste, etc.). The term “non-concentrated tomatoes” used in (iv) refers to a processed tomato product of crushed or ground tomatoes which are not heat-concentrated, and the term “low-concentrated tomatoes” used in (iv) refers to a tomato concentrate obtained by treating crushed or ground tomatoes at a high temperature at which flavor components are difficult to volatilize (e.g., about 95° C.) for a very short period of time (e.g., about 5 minutes) by heat concentration. In (v), unripe tomatoes (with a low degree of ripeness) contain a large amount of 3-hexenol, and fully ripe tomatoes contain 2-isobutylthiazole in a large amount relative to the amount of 3-hexenol. These raw material characteristics can be utilized. In addition, in a case in which a tomato cultivar having high contents of these flavor components is available, it is desirable to select or bleed such cultivar for use.

In the production step according to one or more embodiments of the present invention, conditions in the step of adjusting the Brix of a heat-treated tomato product or a tomato-based food or beverage and conditions in the heat sterilization step are the same as above. The range may have a preferable range, a more preferable range, etc. by the reason described in the description of each item, so these ranges are also the same as above.

### 3. Method for Enhancing and Maintaining Fresh Feeling and Stewed Feeling of a Freshly Cooked Tomato Dish in Heat-Treated Tomato Product or Tomato-Based Food or Beverage

According to the method for producing a heat-treated tomato product or a tomato-based food or beverage, it is possible to enhance and maintain fresh feeling and stewed feeling of a freshly cooked tomato dish in a heat-treated tomato product or a tomato-based food or beverage containing the heat-treated tomato product. Therefore, according to one or more embodiments of the present invention, a method for enhancing and maintaining fresh feeling and stewed feeling of a freshly cooked tomato dish in a heat-treated tomato product or a tomato-based food or beverage containing the heat-treated tomato product by adjusting the contents of flavor components in the heat-treated tomato product and the content ratio thereof is provided. Flavor components to be adjusted in the method, the range of the contents and the content ratio thereof, and the method for adjusting the contents and the content ratio thereof are the same as the above-described method for producing a heat-treated tomato product or a tomato-based food or beverage. In addition, conditions in the step of adjusting the Brix of a heat-treated tomato product or a tomato-based food or beverage and conditions in the heat sterilization step are the same as the above-described method for producing a heat-treated tomato product or a tomato-based food or beverage.

### EXAMPLES

Hereinafter, one or more embodiments of the present invention will be more specifically described in the following examples. However, these examples are not intended to limit the scope of the present invention.

### (Reference Example) Method for Measuring Flavor Components Contained in Heat-Treated Tomato Products

Five milliliters (5 mL) of a sample solution was put in a vial, and 1.5 g of sodium chloride was added thereto. TWISTER (GERSTEL, a stirrer coated with 100% polydimethylsiloxane [PDMS], 0.5 mm in film thickness, 10 mm in length) was placed therein, the vial was capped and stirred at room temperature for 60 minutes for adsorption of flavor components.

Next, the TWISTER was removed from the vial, thoroughly washed with pure water, and then water was wiped off using a paper towel. Then. TWISTER, from which water was wiped off, was set in a thermal desorption system (model code: MPS-TDS, manufactured by GERSTEL), introduced into a GC/MS system, and analyzed.

GC/MS analysis was carried out under the following conditions.

Measuring apparatus: Agilent Technologies, model code: 5975C MSD, column: InertCap WAX (manufactured by GL Sciences Inc., 60 M×0.25 mm I.D.×0.25 μmdf).

Temperature program: retention at 50° C. for 5 minutes, followed by temperature increase to 230° C. at a rate of 2° C./minute

Injection mode: solvent vent mode Carrier gas: helium, flow rate: 1.8 mL % minute Scanning mode: El 70 eV

3-Hexenol was detected in a retention time (RT) of about 28.2 minutes, and the area of an ion having an m/z value of 41.0 was used as corresponding to a quantifier ion. 2-Isobutylthiazole was detected in a retention time (RT) of about 29.2 minutes, and the area of an ion having an m/z value of 99.0 was used as corresponding to a quantifier ion. 6-Methyl-5-hepten-2-one was detected in a retention time (RT) of about 26.7 minutes, and the area of an ion having an m/z value of 43.0 was used as corresponding to a quantifier ion.

For the quantitative determination of each flavor component content (mass concentration), standard samples adjusted to have contents (mass concentrations) of 1 ppb, 10 ppb, and 25 ppb were made using anhydrous ethanol for each of 3-hexenol, 2-isobutylthiazole. 6-methyl-5-hepten-2-one. The same operation as the sample solution was performed, and measurement was performed in the same manner as the method described above.

Meanwhile, the relationship between the content (mass concentration) and the ion area ratio of each flavor component was determined based on the measurement results. As a result, as an example, it was found that when the content (mass concentration) ratio among 3-hexenol and 2-isobutylthiazole and 6-methyl-5-hepten-2-one was 1.5 ppb:1.5 ppb:9.95 ppb, the ion area ratio is 1.0:5.6:15.0. This was defined as the content ratio (mass ratio) of the flavor components.

### (Example 1) Screening of the Flavor Component Capable of Providing Fresh Feeling of a Freshly Cooked Tomato Dish and Stewed Feeling that were Lost by Heat

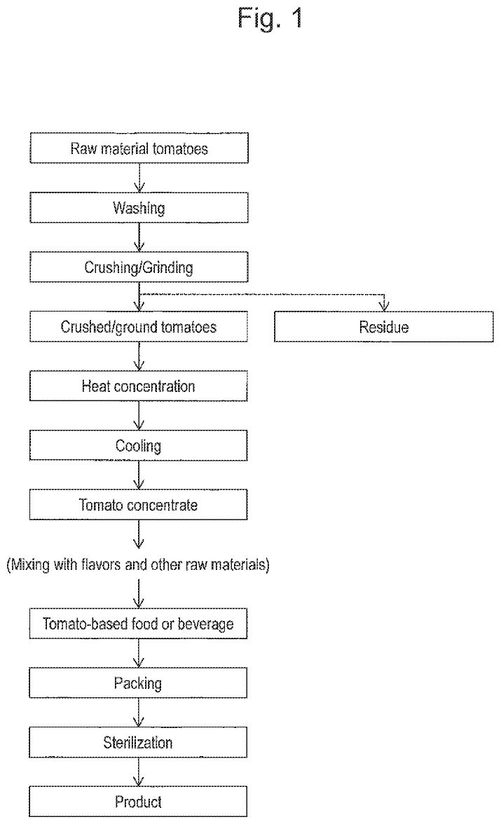

Raw material tomatoes was crushed and heat-concentrated (at 100° C. for 120 minutes) in accordance with the production step of the conventional method in FIG. 1, thereby preparing a tomato concentrate (with Brix adjusted to 30) (hereinafter referred to as “tomato concentrate obtained by the conventional method”). This tomato concentrate (subjected to the heat concentration step) was obviously found to have lost fresh feeling and stewed feeling of a freshly cooked tomato dish. The flavor component analysis of this tomato concentrate was carried out in accordance with the measurement method described in the Reference Example.

As a control, a crushed tomato product (Brix: 6) was prepared using raw material tomatoes of the same cultivar by crushing in the same manner without subsequent heat concentration. Although this crushed tomato product, which was not subjected to heat concentration step, had a light flavor, it had a sufficiently rich flavor equivalent to fresh feeling and stewed feeling of a freshly cooked tomato dish. The flavor component analysis of this crushed tomato product was carried out in accordance with the measurement method described in the Reference Example.

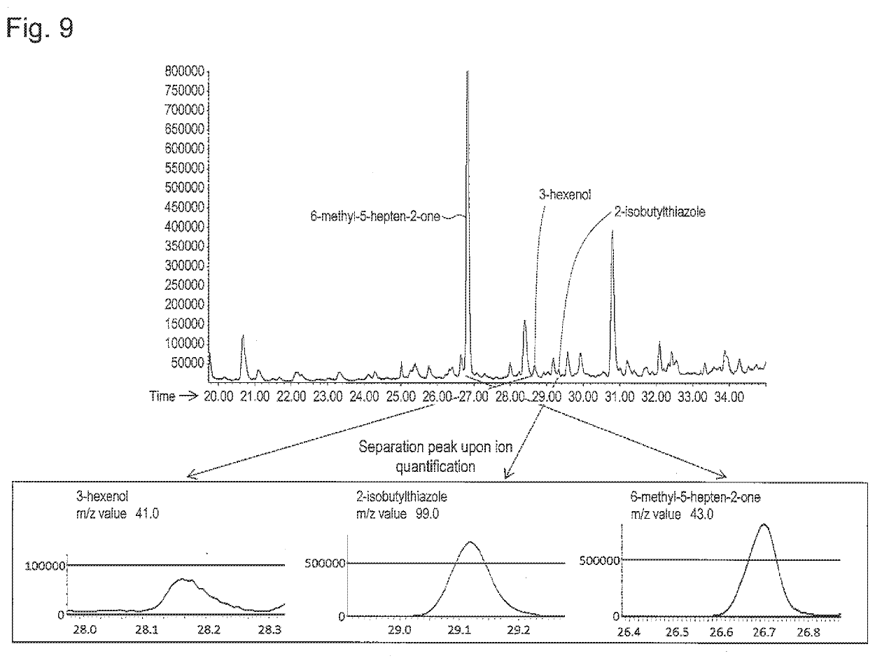

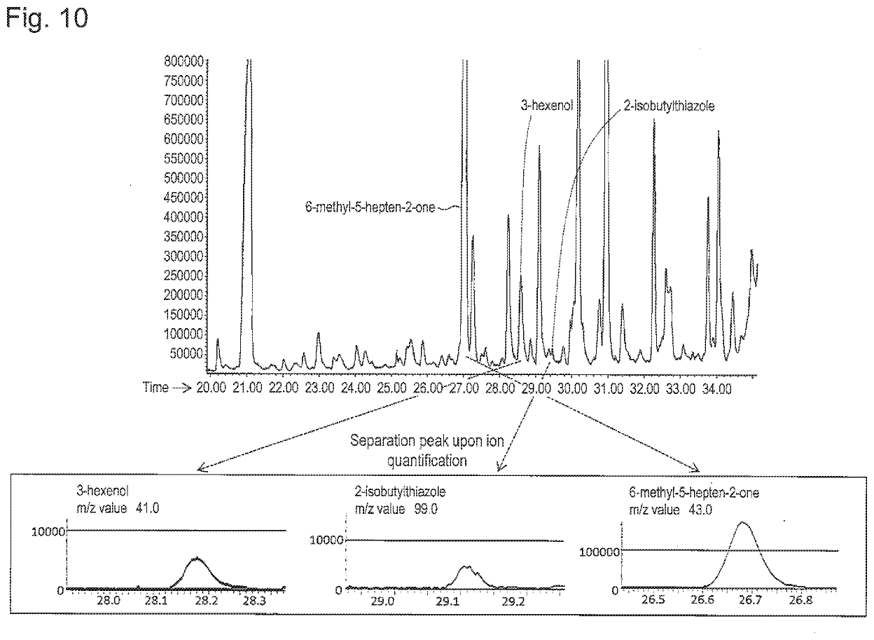

The flavor component analysis results for the tomato concentrate (subjected to the heat concentration step) obtained by the conventional method are shown in FIG. 9, and the flavor component analysis results for the crushed tomato product (not subjected to the heat concentration step) obtained by the conventional method are shown in FIG. 10. Differences in the flavor component compositions in FIGS. 9 and 10 revealed that many flavor components were lost due to heating. However, three components, namely, 3-hexenol, 2-isobutylthiazole, and 6-methyl-5-hepten-2-one, were found to have remained in the tomato concentrate (subjected to the heat concentration step) compared to those in the crushed tomato product (not subjected to the heat concentration step), albeit only slightly. Thus, it was confirmed that these three components have a relatively high heating resistance.

In view of the above test results, the three components (3-hexenol, 2-isobutylthiazole, and 6-methyl-5-hepten-2-one) which showed relatively high levels of heating resistance were screened as candidate compounds capable of providing fresh feeling and stewed feeling of a freshly cooked tomato dish. Here, a tomato concentrate was used as an example of a heat-treated tomato product for verification. Meanwhile, the same results were obtained for a sterilized tomato product and an enzymatically inactivated tomato product.

### (Example 2) Analysis of the Range of 2-Isobutylthiazole Content

### (1) Preparation of Test Samples

3-Hexenol, 2-isobutylthiazole, and 6-methyl-5-hepten-2-one, which were screened in Example 1, have a green grassy smell, a smell of damp soil, and a flowery sweet smell, respectively.

Therefore, based on the assumption that a flavor component having a large influence on fresh feeling and stewed feeling of a freshly cooked tomato dish of a heat-treated tomato product could be 2-isobutylthiazole having the most unique smell, the effect of adding the component was examined. It was found that 2-isobutylthiazole has a quality of a smell that provides stewed feeling rather than fresh feeling of a freshly cooked tomato dish.

In this Example, with respect to 2-isobutylthiazole that was considered to mask fresh feeling of a freshly cooked tomato dish, the range of appropriate contents of 2-isobutylthiazole in the heat-treated tomato product was analyzed.

As an example of a heat-treated tomato product, a tomato concentrate (adjusted to have a Brix value of 34) obtained by the conventional method was appropriately diluted with water for use. A reagent of 2-isobutylthiazole was added thereto at different concentrations, thereby preparing test samples. The 2-isobutylthiazole content in the tomato concentrate (Brix: 34) obtained by the conventional method was 1.5 ppb before the addition of 2-isobutylthiazole. Therefore, 2-isobutylthiazole was added to the test samples (Test Nos. 1 to 10) in amounts corresponding to differences between the above content and the contents shown in Table 1 such that the contents shown in Table 1 were achieved after the addition.

### (2) Sensory Evaluation

Each test sample prepared in (1) was evaluated based on the following criteria. The evaluation was carried out by a cumulative total of five professional panelists in accordance with the following criteria. Evaluation was carried out multiple times.

Evaluation criteria (stewed feeling of a freshly cooked tomato dish)

A: Stewed feeling of a freshly cooked tomato dish is strongly felt.

B: Stewed feeling of a freshly cooked tomato dish is felt.

C: Stewed feeling of a freshly cooked tomato dish is slightly felt.

D: Stewed feeling of a freshly cooked tomato dish is hardly felt.

E: Stewed feeling of a freshly cooked tomato dish is not felt.

The results are shown in Table 1.

TABLE 1
Analysis of 2-isobutylthiazole content

| | | | | | | | | | | |
|---|---|---|---|---|---|---|---|---|---|---|
| Tomato | Test | Test | Test | Test | Test | Test | Test | Test | Test | Test |
| concentrate | No. 1 | No. 2 | No. 3 | No. 4 | No. 5 | No. 6 | No. 7 | No. 8 | No. 9 | No. 10 |

<Component Content (ppb)>

| | | | | | | | | | | |
|---|---|---|---|---|---|---|---|---|---|---|
| 2- | 1.5 | 2.0 | 3.5 | 5.0 | 10.0 | 50.0 | 200.0 | 500.0 | 1000.0 | 2000.0 |
| isobutylthiazole | | | | | | | | | | |

<Items and Results of Sensory Evaluation>
Stewed feeling of freshly cooked tomato dish

| | | | | | | | | | | |
|---|---|---|---|---|---|---|---|---|---|---|
| | D | B | B | A | A | A | B | C | C | D |
| <Remarks> | Taste is | Taste is | Taste is rich | Taste is rich | Taste is rich | Taste is rich | Taste is | Taste is | Taste is | Smell of |
| | plain, stewed | complex, | and | and | and | and | complex, | complex, | complex, | damp soil |
| | feeling is | and | complex, | complex, | complex, | complex, | and | and | and | is too strong, |
| | weak and | preferable | and | and | and | and | preferable | strong | strong | and |
| | not | stewed | particularly | particularly | particularly | particularly | stewed | stewed | stewed | odd taste |
| | preferable. | feeling is | preferable | preferable | preferable | preferable | feeling is | feeling is | feeling is | different |
| | | felt. | stewed | stewed | stewed | stewed | felt. | felt. | felt. | from stewed |
| | | | feeling is | feeling is. | feeling is. | feeling is | | | | feeling is |
| | | | felt. | felt. | felt. | felt. | | | | felt. |

As shown in Table 1, test samples, for which the 2-isobutylthiazole content in the tomato concentrate was in a range of 2.0 ppb to 1000 ppb, provided stewed feeling of a freshly cooked tomato dish and did not induce a sense of discomfort (Test Nos. 2 to 9). It was further revealed that in view of the favorability of the quality of freshly cooked stewed feeling, the 2-isobutylthiazole content may be preferably in a range of 2.0 ppb to 200 ppb (Test Nos. 2 to 7) and more preferably in a range of 5.0 ppb to 50 ppb (Test Nos. 4 to 6). Meanwhile, test samples, for which the 2-isobutylthiazole content in the tomato concentrate did not fall within the above range, provided weak stewed feeling and had an odd smell (Test Nos. 1, Test Nos. 10).

### (Example 3) Analysis of the Content Ratio Between 3-Hexenol and 2-Isobutylthiazole

### (1) Preparation of Test Samples

Test samples were prepared using a tomato concentrate (adjusted to have a Brix value of 34) obtained by the conventional method as an example of a heat-treated tomato product by changing the content ratio between two components, namely, 3-hexenol and 2-isobutylthiazole, which were screened in Example 1. The contents of the above two components in the tomato concentrate (Brix: 34) before the adjustment of the content ratio were set as follows based on the results of Example 2: 2-isobutylthiazole: 32.1 ppb; and 3-hexenol: 150 ppb. In this case, the content ratio (mass ratio) was 3-hexenol:2-isobutylthiazole=1.0:1.2. 3-Hexenol and 2-isobutylthiazole were added to the test samples (Test Nos. 2 to 20) in amounts corresponding to differences between the above contents and the contents shown in Table 2 such that the contents shown in Table 2 were achieved after the addition (Test Nos. 11 to 20).

### (2) Sensory Evaluation

Each test sample prepared in (1) was evaluated based on the following criteria. The evaluation was carried out by a cumulative total of five professional panelists in accordance with the following criteria. Evaluation was carried out multiple times.

Evaluation Criteria 1 (Fresh Feeling of a Freshly Cooked Tomato Dish)

A: Fresh feeling of a freshly cooked tomato dish is strongly felt.

B: Fresh feeling of a freshly cooked tomato dish is felt.

C: Fresh feeling of a freshly cooked tomato dish is slightly felt.

D: Fresh feeling of a freshly cooked tomato dish is hardly felt.

E: Fresh feeling of a freshly cooked tomato dish is not felt.

Evaluation Criteria 2 (Stewed Feeling of a Freshly Cooked Tomato Dish)

A: Stewed feeling of a freshly cooked tomato dish is strongly felt.

B: Stewed feeling of a freshly cooked tomato dish is felt.

C: Stewed feeling of a freshly cooked tomato dish is slightly felt.

D: Stewed feeling of a freshly cooked tomato dish is hardly felt.

E: Stewed feeling of a freshly cooked tomato dish is not felt.

Evaluation Criteria 3 (Overall Handmade Feeling: Balance Between Fresh Feeling and Stewed Feeling of a Freshly Cooked Tomato Dish)

A: Overall handmade feeling is strongly felt.

B: Overall handmade feeling is felt.

C: Overall handmade feeling is slightly felt.

D: Overall handmade feeling is hardly felt.

E: Overall handmade feeling is not felt.

The results are shown in Table 2.

TABLE 2
Analysis of the content ratio between 3-hexenol and 2-isobutylthiazol

| | | | | | | | | | | |
|---|---|---|---|---|---|---|---|---|---|---|
| Tomato | Test | Test | Test | Test | Test | Test | Test | Test | Test | Test |
| concentrate | No. 11 | No. 12 | No. 13 | No. 14 | No. 15 | No. 16 | No. 17 | No. 18 | No. 19 | No. 20 |

<Component Content Ratio (mass ratio)>

| | | | | | | | | | | |
|---|---|---|---|---|---|---|---|---|---|---|
| 3-hexenol | 1 | 1 | 1 | 1 | 1 | 1 | 1 | 1 | 1 | 1 |
| 2-isobutylthiazole | 1.3 | 1.5 | 5.6 | 10 | 12.7 | 15.3 | 17.4 | 20.7 | 25.2 | 30.5 |

<Items and Results of Sensory Evaluation>
Fresh feeling of freshly cooked tomato dish

| | | | | | | | | | |
|---|---|---|---|---|---|---|---|---|---|
| D | B | A | A | A | B | B | C | C | D |

Stewed feeling of freshly cooked tomato dish

| | | | | | | | | | |
|---|---|---|---|---|---|---|---|---|---|
| E | C | B | A | A | A | A | B | C | D |

Overall handmade feeling (balance between fresh feeling and stewed feeling of freshly cooked tomato dish)

| | | | | | | | | | | |
|---|---|---|---|---|---|---|---|---|---|---|
| | D | C | B | A | A | A | B | B | C | D |
| <Remarks> | Fresh | Fresh | Fresh | Balance | Balance | Fresh | Fresh feeling | Fresh feeling | Fresh feeling | Fresh feeling |
| | feeling | feeling is | feding is | between | between | feeling | is slightly | is slightly | is slightly | is |
| | is weak, | preferably | strong and | fresh | fresh | is felt, and | weak, but | weak, and | weak, and | overwhelmed |
| | and | felt. | preferable. | feeling | feeling | stewed | stewed | stewed | stewed | by too strong |
| | stewed | | | and | and | feeling is | feeling is | feeling is | feeling is | stewed |
| | feeling is | | | stewed | stewed | strong and | strong and | stronger, but | slightly | feeling, and |
| | also weak | | | feeling is | feeling is | preferable. | preferable. | preferable. | strong, but | not |
| | and not | | | good and | good and | | | | acceptable. | preferable. |
| | preferable. | | | preferable. | preferable. | | | | | |

As shown in Table 2, the fresh feeling and stewed feeling of a freshly cooked tomato dish were felt when the content ratio (mass ratio) between 3-hexenol and 2-isobutylthiazole was in a range of 1.0:1.5 to 1.0:25.2 (Test Nos. 12 to 19). It was further revealed that in view of the favorability of the quality of fresh feeling and stewed feeling of a freshly cooked tomato dish, the content ratio (mass ratio) between the two components may be preferably in a range of 1.0:5.6 to 1.0:20.7 (Test Nos. 13 to 18), more preferably in a range of 1.0:10.0 to 1.0:15.3 (Test Nos. 14 to 16), and particularly preferably in a range of 1.0:10.0 to 1.0:12.7 (Test Nos. 14 and 15). Meanwhile, in a case in which the content ratio between 3-hexenol and 2-isobutylthiazole did not fall within the above range, the fresh feeling and stewed feeling of a freshly cooked tomato dish were weakly felt, or the balance between both feelings was unsatisfactory (Test Nos. 11 and 20).

### (Example 4) Analysis of the Content Ratio Among 3-hexenol and 2-isobutylthiazole and 6-methyl-5-hepten-2-one

### (1) Preparation of Test Samples

Test samples were prepared using a tomato concentrate (adjusted to have a Brix value of 34) obtained by the conventional method as an example of a heat-treated tomato product by changing the content ratio among three components, namely, 3-hexenol, 2-isobutylthiazole, and 6-methyl-5-hepten-2-one, which were screened in Example 1. The contents of the above three components in the tomato concentrate (Brix: 34) before the adjustment of the content ratio were set as follows: 3-hexenol: 150 ppb; 2-isobutylthiazole: 32.1 ppb; and 6-methyl-5-hepten-2-one: 225 ppb. In this case, the content ratio (mass ratio) was 3-hexenol:2-isobutylthiazole:6-methyl-5-hepten-2-one=1.0:1.2:3.4. 3-Hexenol, 2-isobutylthiazole, and 6-methyl-5-hepten-2-one were added to the test samples (Test Nos. 21 to 36) in amounts corresponding to differences between the above contents and the contents shown in Tables 3-1 and 3-2 such that the contents shown in Tables 3-1 and 3-2 were achieved after the addition.

In this Example, as an example of a tomato-based food or beverage using a heat-treated tomato product, general-purpose tomato sauce, which can be applied to, poured over, or mixed with a food or beverage for use, was prepared and used for evaluation. General-purpose tomato sauce was prepared by adding 8.8% by mass of olive oil, 1% by mass of common salt, 0.1% by mass of garlic powder, and 0.1% by mass of pepper powder to 90% by mass of the above tomato concentrate so as to yield a total of 100% by mass.

### (2) Sensory Evaluation

Each test sample (general-purpose tomato sauce) prepared in (1) was evaluated in the same manner as in Example 3.

The results are shown in Tables 3-1 and 3-2.

TABLE 3-1
Analysis of the content ratio among 3-hexenol and 2-isobutylthiazole and 6-methyl-5-hepten-2-one

| | | | | | | | | |
|---|---|---|---|---|---|---|---|---|
| General-purpose | Test | Test | Test | Test | Test | Test | Test | Test |
| tomato sauce | No. 21 | No. 22 | No. 23 | No. 24 | No. 25 | No. 26 | No. 27 | No. 28 |

<Component Content Ratio (mass ratio)>

| | | | | | | | | |
|---|---|---|---|---|---|---|---|---|
| 3-hexenol | 1 | 1 | 1 | 1 | 1 | 1 | 1 | 1 |
| 2-isobutylthiazole | 1.3 | 1.3 | 1.5 | 1.5 | 1.5 | 1.5 | 5.6 | 5.6 |
| 6-methyl-5- | 4 | 15 | 2 | 4 | 15 | 20 | 2 | 4 |
| hepten-2-one | | | | | | | | |

<Items and Results of Sensory Evaluation>
Fresh feeling of freshly cooked tomato dish

| | | | | | | | |
|---|---|---|---|---|---|---|---|
| D | D | B | A | A | A | A | A |

Stewed feeling of freshly cooked tomato dish

| | | | | | | | |
|---|---|---|---|---|---|---|---|
| E | E | C | C | C | C | B | B |

Overall handmade feeling (balance between fresh feeling and stewed feeling of freshly cooked tomato dish)

| | | | | | | | | |
|---|---|---|---|---|---|---|---|---|
| | D | D | C | A | A | D | B | A |
| <Remarks> | A sense of | A sense of | Fresh feeling is | Fresh feeling is | Fresh feeling | Fresh feeling is | Fresh feeling is | Fresh feeling is |
| | discomfort is | discomfort is | preferably felt. | strong and | is strong and | too strong, and | strong and | strong and |
| | felt in | felt in | Overall flavor | preferable. | preferable. | stewed feeling | preferable. | preferable. |
| | fresh feeling, | fresh feeling, | is slightly | Overall flavor | Overall | is weak. | Balance between | Overall flavor is |
| | and stewed | and stewed | weak but | is strong. | flavor | | fresh feeling and | strong, and |
| | feeling is | feeling is | acceptable. | | is strong. | | stewed feeling is | balance between |
| | also | also | | | | | also good and | fresh feeling and |
| | weak and not | weak and not | | | | | preferable. | stewed feeling is |
| | preferable. | preferable. | | | | | | also good and |
| | | | | | | | | particularly |
| | | | | | | | | preferable. |

TABLE 3-2
Analysis of the content ratio among 3-hexenol and 2-isobutylthiazole and 6-methyl-5-hepten-2-one

| | | | | | | | | |
|---|---|---|---|---|---|---|---|---|
| General-purpose | Test | Test | Test | Test | Test | Test | Test | Test |
| tomato sauce | No. 29 | No. 30 | No. 31 | No. 32 | No. 33 | No. 34 | No. 35 | No. 36 |

<Component Content Ratio (mass ratio)>

| | | | | | | | | |
|---|---|---|---|---|---|---|---|---|
| 3-hexenol | 1 | 1 | 1 | 1 | 1 | 1 | 1 | 1 |
| 2-isobutylthiazole | 5.6 | 5.6 | 10 | 10 | 10 | 10 | 12.7 | 12.7 |
| 6-methyl-5- | 15 | 20 | 2 | 4 | 15 | 20 | 4 | 15 |
| hepten-2-one | | | | | | | | |

<Items and Results of Sensory Evaluation>
Fresh feeling of freshly cooked tomato dish

| | | | | | | | |
|---|---|---|---|---|---|---|---|
| A | A | A | A | A | B | C | D |

Stewed feeling of freshly cooked tomato dish

| | | | | | | | |
|---|---|---|---|---|---|---|---|
| B | C | A | A | A | C | D | E |

Overall handmade feeling (balance between fresh feeling and stewed feeling of freshly cooked tomato dish)

| | | | | | | | | |
|---|---|---|---|---|---|---|---|---|
| | A | D | B | A | A | D | D | E |
| <Remarks> | Fresh feeling is | Fresh | Balance | Balance between | Balance between | Balance between | Balance between | Balance |
| | strong and | feeling | between | fresh feeling and | fresh feeling and | fresh feeling and | fresh feeling and | between |
| | preferable. | is too | fresh | stewed feeling is | stewed feeling is | stewed feeling is | stewed feeling is | fresh feeling |
| | Overall flavor is | strong | feeling | good and | good and | poor, and a | poor, and a | and stewed |
| | strong, and | while | and | preferable. | preferable. | sense of | sense of | feeling is |
| | balance between | stewed | stewed | Overall flavor is | Overall flavor is | discomfort is felt. | discomfort is felt. | poor, and |
| | fresh feeling and | feeling | feeling is | strong. | strong. | | | a strong |
| | stewed feeling is | is weak. | good and | | | | | sense of |
| | good and | | preferable. | | | | | discomfort |
| | particularly | | | | | | | is felt. |
| | preferable. | | | | | | | |

As shown in Tables 3-1 and 3-2, regarding the fresh feeling and stewed feeling of a freshly cooked tomato dish derived from a combination of 3-hexenol, 2-isobutylthiazole, and 6-methyl-5-hepten-2-one, it was found that when the content ratio (mass ratio) between 3-hexenol and 2-isobutylthiazole is in a range of 1.0:1.5 to 1.0:10.0 and the content ratio (mass ratio) between 3-hexenol and 6-methyl-5-hepten-2-one is in a range of 1.0:2.0 to 1.0:15.0, the fresh feeling and stewed feeling of a freshly cooked tomato dish can be more effectively enhanced (Test Nos. 23, 24, 25, 27, 28, 29, 31, 32, and 33), compared to the case of only the two components (3-hexenol and 2-isobutylthiazole) in Example 3. It was also found that in view of the overall flavor, it may be more preferable that the content ratio (mass ratio) between 3-hexenol and 6-methyl-5-hepten-2-one is in a range of 1.0:4.0 to 1.0:15.0 (Test Nos. 24, 25, 28, 29, 32, and 33). The above results revealed that in view of the favorability of the quality of fresh feeling and stewed feeling of a freshly cooked tomato dish, the content ratio (mass ratio) among the three components (3-hexenol, 2-isobutylthiazole, and 6-methyl-5-hepten-2-one) may be preferably in a range of 1.0:1.5:2.0 to 1.0:10.0:15.0 (Test Nos. 23, 24, 25, 27, 28, 29, 31, 32, and 33) and more preferably in a range of 1.0:1.5:4.0 to 1.0:10.0:15.0 (Test Nos. 24, 25, 28, 29, 32, and 33). Meanwhile, in a case in which the content ratio among the above three components did not fall within the above range, the fresh feeling and stewed feeling of a freshly cooked tomato dish were weakly felt, or the balance between both feelings was unsatisfactory (Test Nos. 21, 22, 26, 30, 34, 35, and 36). Further, it was also confirmed that even the general-purpose tomato sauce to which fats and oils, seasonings, and spicy seasonings were added did not affect the above effects.

### (Example 5) Analysis of the Appropriate Brix Range of Heat-Treated Tomato Products

### (1) Preparation of Test Samples

Test samples were prepared using a tomato concentrate (adjusted to have a Brix value of 34) obtained by the conventional method as an example of a heat-treated tomato product by changing Brix. 3-Hexenol, 2-isobutylthiazole, and 6-methyl-5-hepten-2-one were added to a tomato concentrate (Brix 34) before the adjustment of Brix based on the results of Example 4 so as to yield a content ratio (mass ratio) of 1.0:5.6:15.0. In this case, the contents of the components in the tomato concentrate were as follows: 3-hexenol: 150 ppb; 2-isobutylthiazole: 150 ppb; and 6-methyl-5-hepten-2-one: 995 ppb. Test samples which were different only in terms of Brix were prepared by diluting the tomato concentrate (Brix 34) with water and adding common salt thereto to yield a salt concentration of 1% so as to adjust the taste to a certain level (Test Nos. 37 to 42).

### (2) Sensory Evaluation

Each test sample prepared in (1) was evaluated in the same manner as in Example 3.

The results are shown in Table 4.

TABLE 4
Analysis of Brix range

| | | | | | | |
|---|---|---|---|---|---|---|
| General-purpose | Test | Test | Test | Test | Test | Test |
| tomato sauce | No. 37 | No. 38 | No. 39 | No. 40 | No. 41 | No. 42 |

<Brix>

| | | | | | |
|---|---|---|---|---|---|
| 3 | 6 | 10 | 20 | 30 | 34 |

<Component content ratio (mass ratio)>

| | | | | | | |
|---|---|---|---|---|---|---|
| 3-hexenol | 1 | 1 | 1 | 1 | 1 | 1 |
| 2-isobutylthiazole | 5.6 | 5.6 | 5.6 | 5.6 | 5.6 | 5.6 |
| 6-methyl-5- | 15 | 15 | 15 | 15 | 15 | 15 |
| hepten-2-one | | | | | | |

<Items and Results of Sensory Evaluation>
Overall handmade feeling (balance between fresh feeling and stewed feeling
of freshly cooked tomato dish)

| | | | | | | |
|---|---|---|---|---|---|---|
| | E | C | A | A | B | B |
| <Remarks> | Taste is too | Taste is slightly | Taste is appropriately | Taste is appropriately | Taste is relatively | Taste is relatively |
| | light, and no | light, but effects | strong, and effects are | strong, and effects are | strong, but effects are | strong, but effects are |
| | effects are felt. | are felt. | felt. | felt. | felt. | felt. |

As shown in Table 4, when the Brix value of the tomato concentrate was in a range of 6 to 34, the fresh feeling and stewed feeling of a freshly cooked tomato dish were enhanced, thereby improving preference (Test Nos. 38 to 42). Further, it was found that in view of the ease of feeling the aroma added to the tomato concentrate, the Brix of the tomato concentrate may be preferably in a range of 10 to 34 (Test Nos. 39 to 42) and more preferably in a range of 10 to 20 (Test Nos. 39 of 40). Meanwhile, in a case in which the Brix value did not fall within the above range, the fresh feeling and stewed feeling of a freshly cooked tomato dish were weakly felt, or the balance between both feelings was unsatisfactory (Test No. 37).

### (Example 6) Influence of Heat Sterilization on Tomato-Based Foods or Beverages

### (1) Preparation of Test Samples

A tomato concentrate prepared in the same manner as in Example 5 (3-hexenol:2-isobutylthiazole:6-methyl-5-hepten-2-one=1.0:5.6:15.0 (content ratio (mass ratio), 3-hexenol content=150 ppb, 2-isobutylthiazole content=150 ppb, 6-methyl-5-hepten-2-one content=995 ppb, Brix adjusted to 34) was used, and the Brix value was adjusted to 20 based on the results of Example 5.

General-purpose tomato sauce, which can be applied to, poured over, or mixed with a food or beverage for use, was prepared by adding 8.8% by mass of olive oil, 1% by mass of common salt, 0.1% by mass of garlic powder, and 0.1% by mass of pepper powder to 90% by mass to the above tomato concentrate so as to yield a total of 100% by mass. The prepared general-purpose tomato sauce was heat-sterilized under various conditions and water-cooled to normal temperature, thereby preparing test samples subjected to different heat sterilization treatment conditions (Test Nos. 43 to 50).

### (2) Sensory Evaluation

Each test sample (general-purpose tomato sauce) prepared in (1) was evaluated in the same manner as in Example 3.

The results are shown in Table 5.

TABLE 5
Analysis of heat sterilization conditions

| | | | | | | | | |
|---|---|---|---|---|---|---|---|---|
| Tomato based | Test | Test | Test | Test | Test | Test | Test | Test |
| pasta sauce | No. 43 | No. 44 | No. 45 | No. 46 | No. 47 | No. 48 | No. 49 | No. 50 |

Sterilization temperature (° C.)

| | | | | | | | |
|---|---|---|---|---|---|---|---|
| 70 | 70 | 70 | 70 | 100 | 100 | 100 | 100 |

Sterilization time (min)

| | | | | | | | |
|---|---|---|---|---|---|---|---|
| 3 | 10 | 20 | 30 | 3 | 10 | 20 | 30 |

<Items and Results of Sensory Evaluation>
Overall handmade feeling (balance between fresh feeling and stewed feeling of freshly
cooked tomato dish)

| | | | | | | | | |
|---|---|---|---|---|---|---|---|---|
| | A | A | B | D | A | B | C | E |
| <Remarks> | No change. | No change. | Aroma was | Aroma was | No change. | Aroma was | Aroma was | Aroma was |
| | | | slightly | dispersed and | | slightly | weakened but | dispersed and |
| | | | weakened but | fresh feeling was | | weakened but | acceptable. | fresh feeling was |
| | | | difference was | lost. | | difference was | | lost. |
| | | | small. | | | small. | | |

As shown in Table 5, it was found that heat sterilization treatment conditions for maintaining fresh feeling and stewed feeling of a freshly cooked tomato dish provided by adding the flavor components as described above may be conditions of heat sterilization treatment at 70° C. to 100° C. for 3 minutes to 20 minutes (Test Nos. 43, 44, 45, 47, 48, and 49). It was also found that from the viewpoint of maintaining the fresh feeling and stewed feeling of a freshly cooked tomato dish, conditions of heat sterilization treatment at 70° C. to 100° C. for 3 minutes to 10 minutes may be more preferable (Test Nos. 43, 44, and 47). Meanwhile, when heat sterilization treatment conditions did not fall within the above range, the aroma was dispersed, resulting in loss of the fresh feeling (Test Nos. 46 and 50).

### (Example 7) Analysis of the Appropriate Range of the Heat-Treated Tomato Product Content of Tomato-Based Foods or Beverages

### (1) Preparation of Test Samples

A tomato concentrate prepared in the same manner as in Example 5 (3-hexenol:2-isobutylthiazole:6-methyl-5-hepten-2-one=1.0:5.6:15.0 (content ratio (mass ratio), 3-hexenol content=150 ppb, 2-isobutylthiazole content=150 ppb, 6-methyl-5-hepten-2-one content=995 ppb, Brix adjusted to 34) was used, and the Brix value was adjusted to 20 based on the results of Example 5.

As an example of a tomato-based food or beverage, tomato-based Mediterranean pasta sauce was prepared using the above tomato concentrate.

Aside from the above tomato concentrate, an oil seasoning for flavoring was prepared by mixing olive oil with 10 parts by mass of red wine as an ethanol-containing product or a nikiri-product thereof, 5 parts by mass of balsamic vinegar as an acetic acid-containing product or a nikiri-product thereof, 10 parts by mass of chopped anchovy paste as a food ingredient, 5 parts by mass of black pepper as a spicy seasoning, 10 parts by mass of chopped olive as an aromatic material, 5 parts by mass of common salt, 3 parts by mass of sugar, and 2 parts by mass of a nucleic acid-based seasoning so as to yield a total of 100 parts by mass. The oil seasoning for flavoring was mixed with the above tomato concentrate at proportions shown in Table 6, thereby preparing various types of pasta sauce at different contents of the tomato concentrate (Test Nos. 51 to 57). The prepared tomato-based Mediterranean pasta sauce was heat-sterilized at 80° C. for 5 minutes and water-cooled to normal temperature based on the results of Example 6, and mixed with boiled pasta.

### (2) Sensory Evaluation

Each test sample prepared in (1) was evaluated in the same manner as in Example 3.

The results are shown in Table 6.

TABLE 6
Analysis of tomato concentrate content in tomato-based food or beverage

| | | | | | | | |
|---|---|---|---|---|---|---|---|
| Tomato-based pasta | Test | Test | Test | Test | Test | Test | Test |
| sauce (Mediterranean) | No. 51 | No. 52 | No. 53 | No. 54 | No. 55 | No. 56 | No. 57 |

Tomato concentrate (parts by mass)

| | | | | | | |
|---|---|---|---|---|---|---|
| 5 | 10 | 20 | 40 | 60 | 80 | 100 |

Oil seasoning for flavoring (parts by mass)

| | | | | | | |
|---|---|---|---|---|---|---|
| 95 | 90 | 80 | 60 | 40 | 20 | 0 |

<Items and Results of Sensory Evaluation>
Overall handmade feeling (balance between fresh feeling and stewed feeling
of freshly cooked tomato dish)

| | | | | | | | |
|---|---|---|---|---|---|---|---|
| | E | D | C | B | A | A | A |
| <Remarks> | Tomato | Tomato | Fresh feeling is | Fresh feeling and | Fresh feeling and | Fresh feeling and | Fresh feeling and |
| | flavor is | favor is weak. | slightly felt. | stewed feeling are | stewed feeling are | stewed feeling are | stewed feeling are |
| | not felt. | | | felt. | strongly felt, | strongly felt, | strongly felt, |
| | | | | | preferable as pasta | preferable as pasta | preferable as pasta |
| | | | | | sauce. | sauce. | sauce. |

As shown in Table 6, the fresh feeling and stewed feeling of a freshly cooked tomato dish were felt when the content of the tomato concentrate in the tomato pasta sauce was in a range of 20% by mass to 100% by mass (Test Nos. 53 to 57). In addition, it was found that in view of the strength of the fresh feeling and stewed feeling and the favorability of the flavor of pasta sauce, the content may be more preferably in a range of 40% by mass to 100% by mass (Test Nos. 54 to 57) and further preferably in a range of 60% by mass to 100% by mass (Test Nos. 55 to 57). Meanwhile, in a case in which the content of the tomato concentrate in the tomato pasta sauce did not fall within the above range, the tomato flavor was weakly felt or not felt (Test Nos. 51, 52).

### (Example 8) Effects of Enhancing Fresh Feeling and Stewed Feeling of a Freshly Cooked Tomato Dish by Various Production Methods

### (1) Preparation of Test Samples

A tomato concentrate (Brix adjusted to 34) obtained by the conventional method was used as an example of a heat-treated tomato product. Test samples were prepared by a method for adding flavor components to a tomato concentrate (FIG. 2), a method for adding a flavoring agent containing flavor components to a tomato concentrate (FIG. 3), a method for adding a food material containing flavor components to a tomato concentrate (FIG. 4), or a method for mixing low-concentrated tomatoes with a tomato concentrate (FIG. 5) such that the content ratio (mass ratio) among 3-hexenol, 2-isobutylthiazole, and 6-methyl-5-hepten-2-one as the components in the tomato concentrate was adjusted to 1.0:5.6:15.0 based on the results of Example 4 (Test Nos. 59 to 62). In addition, for comparison, a tomato concentrate was prepared by the production step of the conventional method (FIG. 1) (Test No. 58).

In the method for adding a flavoring agent containing flavor components to a tomato concentrate (FIG. 3), a flavor component dissolved in ethanol was used. In the method for adding a food material containing flavor components to a tomato concentrate (FIG. 4), canned tomatoes and paprikas were used as food materials. In the method for mixing a low-concentrated tomato product with a tomato concentrate (FIG. 5), low-concentrated tomato paste having a Brix value of 9 was used as a low-concentrated tomato product.

### (2) Sensory Evaluation

Each test sample prepared in (1) was evaluated in the same manner as in Example 3.

The results are shown in Table 7.

TABLE 7
Effects of enhancing fresh feeling and stewed feeling of freshly cooked tomato dish by various production methods

| | | | | | |
|---|---|---|---|---|---|
| Tomato | Test | Test | Test | Test | Test |
| concentrate | No. 58 | No. 59 | No. 60 | No. 61 | No. 62 |

<Production Step>

| | | | | |
|---|---|---|---|---|
| Conventional method | Addition of flavor | Addition of | Addition of food material | Addition of low-concentrated |
| (FIG. 1) | components per se | flavoring agent | (FIG. 4) | tomato |
| | (FIG. 2) | (FIG. 3) | | (FIG. 5) |

<Items and Results of Sensory Evaluation>
Overall handmade feeling (balance between fresh feeling and stewed feeling of freshly cooked tomato dish)

| | | | | | |
|---|---|---|---|---|---|
| | E | A | A | B | A |
| <Remarks> | Overall handmade feeling is | Overall handmade | Overall handmade | Overall handmade feeling is | Overall handmade feeling is |
| | not felt because of plain | strongly felt. | feeling is strongly felt. | felt. Other aromas are also | strongly felt. |
| | flavor. | | | slightly added, which | |
| | | | | however are sufficiently | |
| | | | | acceptable. | |

As shown in Table 7, it was verified that compared to the tomato concentrate obtained by the conventional method in FIG. 1 (Test No. 58), the tomato concentrates produced by the methods in FIG. 2 to 5 (Test Nos. 59 to 62) are able to provide fresh feeling and stewed feeling of a freshly cooked tomato dish and have an improved quality of preference. A verification test was not carried out for the method using raw material tomatoes of a tomato cultivar and/or unripe fruits having high flavor component contents in FIG. 6. However, since the effects according to one or more embodiments of the present invention were confirmed by the method for adding a food material containing flavor components in FIG. 4, it is obviously understood that a tomato concentrate capable of easily providing the effects according to one or more embodiments of the present invention could be prepared by the method in FIG. 6.

### (Example 9) Feature of Maintaining Freshly Cooked Feeling and Stewed Feeling

### (1) Preparation of Test Samples

A tomato concentrate was prepared by adding a flavoring agent containing 3-hexenol, 2-isobutylthiazole, and 6-methyl-5-hepten-2-one as components and other flavor components to a tomato concentrate (adjusted to have a Brix value of 34) obtained by the conventional method as an example of a heat-treated tomato product. The content ratio (mass ratio) among 3-hexenol, 2-isobutylthiazole, and 6-methyl-5-hepten-2-one contained as components in this tomato concentrate was 1.0:1.5:4.0.

General-purpose tomato pasta sauce was prepared by mixing 40 parts by mass of the above tomato concentrate obtained by the conventional method (Brix: 34) or a tomato concentrate to which the above flavor components are added, 5 parts by mass of dried onion, 0.5 parts by mass of dried garlic, 0.4 parts by mass of dried basil, 0.1 parts by mass of pepper powder, 4 parts by mass of olive oil, and 50 parts by mass of water.

The prepared pasta sauce (the tomato concentrate obtained by the conventional method or the tomato concentrate to which the flavor components are added) was heat-sterilized at 95° C. for 10 minutes and cooled to normal temperature based on the results of Example 6, and then preserved at 40° C. for 25 days or 35 days, thereby preparing test samples of pasta sauce preserved under different conditions (Test Nos. 63 to 65). Preservation at 40° C. for 25 days corresponds to preservation at normal temperature for 4 months, and preservation at 40° C. for 35 days corresponds to preservation at normal temperature for 6 months.

### (2) Sensory Evaluation

Each test sample prepared in (1) was evaluated in the same manner as in Example 3.

The results are shown in Table 8.

TABLE 8
Retention of fresh feeling and stewed feeling of a freshly cooked tomato dish

| | | | |
|---|---|---|---|
| General-purpose tomato | Test | Test | Test |
| pasta sauce | No. 63 | No. 64 | No. 65 |

<Preservation Period (Room temperature)>

| | | |
|---|---|---|
| Immediately after the | Preservation | Preservation |
| production | corresponding to normal | corresponding to normal |
| | temperature for 4 months | temperature for 6 months |

<Items and Results of Sensory Evaluation>
Overall handmade feeling (balance between fresh feeling and stewed feeling of
freshly cooked tomato dish)

| | | | |
|---|---|---|---|
| Tomato concentrate | C | D | D |
| obtained by the | | | |
| conventional method | | | |
| Tomato concentrate to | A | A | B |
| which the flavor | | | |
| components are added | | | |

| | |
|---|---|
| <Remarks> | Overall handmade feeling of the pasta sauce |
| | prepared by the conventional method is weak from the beginning |
| | and changes to a plain taste over time. |
| | Overall handmade feeling is provided by addition of flavor components |
| | and is maintained for a long period of time. |

As shown in Table 8, the pasta sauce prepared using the tomato concentrate to which the flavor components are added was found to provide strong fresh feeling and stewed feeling of a freshly cooked tomato dish immediately after being prepared and have the effects that hardly change over time. Meanwhile, the flavor of the pasta sauce prepared using the tomato concentrate obtained by the conventional method changed to a plain flavor, and the pasta sauce had a tendency to provide weakened fresh feeling and stewed feeling of a freshly cooked tomato dish over time during the preservation period. Therefore, it was verified that the pasta sauce according to one or more embodiments of the present invention can maintain its product quality for a long period of time even in an actual production and sales environment.

A “tomato concentrate” was selected as an example of a heat-treated tomato product to conduct various evaluation tests in the Examples described above. Similarly, it is obviously understood that the same can also apply to a sterilized and enzymatically inactivated heat-treated tomato product subjected to heat treatment in terms of the influence of heat on the tomato flavor, the effects according to one or more embodiments of the present invention provided with the addition of flavor components, although there is a difference in the degree of influence depending on the degree of heat treatment.

The present invention can be used in the field of manufacturing heat-treated tomato products and tomato-based foods or beverages.

All publications, patents and patent applications cited in the present description are incorporated herein by reference in their entirety.

Although the disclosure has been described with respect to only a limited number of embodiments, those skilled in the art, having benefit of this disclosure, will appreciate that various other embodiments may be devised without departing from the scope of the present invention. Accordingly, the scope of the present invention should be limited only by the attached claims.

What is claimed is:

1. A heat-treated tomato product, comprising a heat-treated tomato containing 3-hexenol and 2-isobutylthiazole,
wherein a content of 2-isobutylthiazole in the heat-treated tomato product ranges from 2.0 to 1000 ppb, and a mass ratio of 3-hexenol to 2-isobutylthiazole in the heat-treated tomato product ranges from 1.0:1.5 to 1.0:25.2.

2. The heat-treated tomato product according to claim 1, wherein the heat-treated tomato further contains 6-methyl-5-hepten-2-one,
wherein the mass ratio of 3-hexenol to 2-isobutylthiazole ranges from 1.0:1.5 to 1.0:10.0, and a mass ratio of 3-hexenol to 6-methyl-5-hepten-2-one in the heat-treated tomato product ranges from 1.0:2.0 to 1.0:15.0.

3. The heat-treated tomato product according to claim 1, wherein the heat-treated product has a Brix value of 6 to 34.

4. The heat-treated tomato product according to claim 1, wherein the heat-treated tomato product is sterilized by heat sterilization at 70 to 100° C. for 3 to 20 minutes.

5. A tomato-based food or beverage, comprising the heat-treated tomato product according to claim 1.

6. The tomato-based food or beverage according to claim 5, wherein a content of the heat-treated tomato product in the tomato-based food or beverage is 20 to 100% by mass.

7. The tomato-based food or beverage according to claim 5, wherein the tomato-based food or beverage is sterilized by heat sterilization at 70 to 100° C. for 3 to 20 minutes.

8. A method for producing a heat-treated tomato product, comprising:
crushing or grinding raw material tomatoes:
preparing a heat-treated tomato comprising flavor components by heating the crushed or ground tomatoes, wherein the flavor components comprise 2-isobutylthiazole and 3-hexenol; and
adjusting contents of the flavor components in the heat-treated tomato product, wherein a content of 2-isobutylthiazole in the heat-treated tomato product is adjusted to be in a range of 2.0 to 1000 ppb, and a mass ratio of 3-hexenol to 2-isobutylthiazole in the heat-treated tomato product is adjusted to be in a range of 1.0:1.5 to 1.0:25.2.

9. The method according to claim 8,
wherein the flavor components comprise 6-methyl-5-hepten-2-one,
wherein adjusting the contents of the favor components comprises adjusting a content of 6-methyl-5-hepten-2-one in the heat-treated tomato product, and
wherein the mass ratio of 3-hexenol to 2-isobutylthiazole is adjusted to be in a range of 1.0:1.5 to 1.0:10.0, and a mass ratio of 3-hexenol to 6-methyl-5-hepten-2-one in the heat-treated tomato product is adjusted to be in a range of 1.0:2.0 to 1.0:15.0.

10. The method according to claim 8, wherein adjusting the contents of the flavor components is performed by one or more selected from the group consisting of:
adding the flavor components to the heat-treated tomato product;
adding a flavoring agent containing the flavor components to the heat-treated tomato product;
adding a food material containing the flavor components to the heat-treated tomato product;
mixing non-concentrated tomatoes and/or low-concentrated tomatoes with the heat-treated tomato product; and
selecting a tomato cultivar having high contents of the flavor components and/or unripe tomatoes having high contents of the flavor components as the raw material tomatoes.

11. The method according to claim 8, further comprising mixing the heat-treated tomato product with other raw materials such that a content of the heat-treated tomato in the mixture is adjusted to 20 to 100% by mass.

12. The method according to claim 8, further comprising adjusting a Brix value of the heat-treated tomato product to be in a range of 6 to 34.

13. The method according to claim 8, further comprising sterilizing the heat-treated tomato product by heat sterilization at 70 to 100° C. for 3 to 20 minutes.

14. The heat-treated tomato product produced by the method according to claim 8.
